(19) United States
(12) Patent Application Publication
(10) Pub. No.: US 2014/0200724 A1
(43) Pub. Date: Jul. 17, 2014

(54) Methods and Systems for Bidirectional Charging of Electrical Devices Via an Electrical System

(71) Applicant: Eric Sortomme, Bothell, WA (US)

(72) Inventor: Eric Sortomme, Bothell, WA (US)

(73) Assignee: University of Washington Through Its Center For Commercialization, Seattle, WA (US)

(21) Appl. No.: 14/234,184

(22) PCT Filed: Aug. 15, 2012
(86) PCT No.: PCT/US2012/050907

§ 371 Date: Feb. 24, 2014

Related U.S. Application Data
(60) Provisional application No. 61/523,666, filed on Aug. 15, 2011.

(51) Int. Cl. H02J 4/00

(52) U.S. Cl. CPC H02J 4/00
USPC 700/291

(57) ABSTRACT

Disclosed herein are methods, systems, and devices that may be implemented by an energy aggregator to control, or regulate, the electric load placed on an electric grid by an aggregation of electrical devices, such as electric vehicles. Generally, the disclosed methods and systems may provide for the bidirectional modulation of the power draw of each electric vehicle around a first power draw, or scheduled power draw. Further, the disclosed methods and systems provide for the determination of a desirable scheduled power draw for a given electric vehicle. In one example, the scheduled power draw may be determined based on, among other things, a respective amount of projected degradation in a given time period of each electrical device from a set of electrical devices. In another example, the scheduled power draw may be determined based on, among other considerations, a maximization of the profit derived by the energy aggregator for both providing power to an aggregation of electric vehicles and for providing a regulation function to the electrical grid (at the request, for example, of an electrical-system operator).

### RELATED APPLICATIONS

This application claims priority to U.S. Provisional Patent Application Ser. No. 61/523,666 filed Aug. 15, 2011, entitled Optimal Scheduling of Vehicle-to-Grid Energy and Ancillary Services, which is incorporated herein by reference in its entirety.

### BACKGROUND

Today, power is typically generated by a given power-generation source (e.g., a coal-, natural gas-, nuclear-, hydro-, or oil-based power plant, and/or, increasingly, some other renewable energy source, such as wind or solar) and then transmitted and distributed throughout a given geographic region via an electrical grid. Entities that generate, transmit, and/or distribute power may be referred to as utilities, while entities that coordinate, control, and/or monitor electricity transmission throughout the electrical grid may be referred to as electrical-system operators (e.g., a regional transmission organization (RTO) or an independent system operator (ISO)). Grids covering large geographic regions, such as the United States, may consist of a patchwork of utilities and operators.

Individuals increasingly demand inexpensive and more power to support various activities—yet those same individuals, generally, do not desire to have that energy produced near their homes (e.g., by power plants, which may generate, in addition to power, pollution, noise, etc.). To address this problem, utilities and operators attempt to generate and distribute power in a manner that is as efficient and unobtrusive as possible. As a result, advances in efficient approaches to energy management, e.g., efficient approaches to energy generation, transmission, and distribution, are clearly desired.

One recent approach to efficient energy management involves the aggregation of many electrical devices connected to an electrical grid (including those that are relatively small consumers/resources of energy) by an energy aggregator, such that the many electrical devices may be treated as a single, significant entity that is connected to the electrical grid. Thereby, such energy aggregators may enable an electrical-system operator, and other entities associated with the electrical grid more generally, to treat the aggregated electrical devices as a power generation source and/or a storage device. Within this configuration, it may be possible to control the aggregated electrical devices in a unidirectional and/or a bidirectional manner. For instance, in the unidirectional case, the respective power draw of the aggregated electrical devices may be controlled such that those electrical devices are treated as a controllable load. And in the bidirectional case, the energy stored in aggregated electrical devices may also be pumped back into the electrical grid.

### SUMMARY OF THE INVENTION

Recent advancements in electric vehicles suggest that electric vehicles are poised to become more and more pervasive in coming years. As such, electric vehicles (which, generally, run on power supplied by a battery), may be one type of electrical device well suited for control via an energy-aggregation arrangement. Other examples of electrical devices well suited for control via an energy-aggregation arrangement may exist as well.

While it has been speculated that unidirectional control of electric vehicles may be implemented before bidirectional control of electric vehicles, unidirectional control of aggregated vehicles has several limitations. One such limitation is that the energy provisioning and regulation services that may be provided in a unidirectional arrangement are significantly limited compared to a bidirectional arrangement. This is largely due to the fact that, in a unidirectional arrangement, the electrical vehicles may not provide the electrical system with energy stored in their respective batteries. Conversely, in a bidirectional arrangement, the electrical vehicles may provide the electrical system with energy stored in their respective batteries.

Thus, bidirectional control of aggregated electric vehicles may be desirable, for example, at least because it enables an energy aggregator to cause the aggregated vehicles to both consume energy from and provide energy to the electrical grid. However, bidirectional power flow results in increased cycling wear on batteries and, therefore, decreased lifetimes of batteries. And, not insignificantly, consumers may be resistant to allowing a utility to pull energy from the batteries of their electric vehicles. Such drawbacks of bidirectional control may apply to the aggregation of electrical devices other than electric vehicles.

Thus, in an arrangement that implements bidirectional control of aggregated electrical devices, such as electrical vehicles, it may be desirable to account for the degradation of batteries due to the discharging of batteries and/or the impact on consumers due to discharging energy from their electric vehicles. Nonetheless, efforts thus far to optimize bidirectional control of electric devices have failed to do so, and have also proven inadequate in various other respects as well.

Accordingly, disclosed herein are methods, systems, and devices that enable the efficient bidirectional control of respective power draws of various electrical devices in an electrical system. According to the disclosed methods, systems, and devices, an energy aggregator (or some other component) may control the electric load placed on an electric grid by an aggregation of electrical devices, such as electric vehicles. For instance, the energy aggregator may modulate the power draw of each electric vehicle around a first power draw (e.g., a scheduled power draw). Further, the energy aggregator may determine a desirable scheduled power draw for a given electric vehicle. In one example, the scheduled power draw may be determined based on, among other things, a respective amount of projected degradation in a given time period of each electrical device from a set of electrical devices.

In another example, the scheduled power draw may be determined based on, among other considerations, a maximization of the profit derived by the energy aggregator for both providing power to an aggregation of electric vehicles and for providing a regulation function to the electrical grid (at the request, for example, of an electrical-system operator).

A first embodiment of the disclosed methods, systems, and devices may take the form of a method that includes: (a) determining, based on at least a respective amount of projected degradation in a given time period of each electrical device from a set of electrical devices, a respective first power draw of each electrical device for the given time period, where each electrical device is coupled to an electrical system; (b) receiving, from an electrical system operator, a regulation-variance value that indicates a variation from a scheduled power consumption of the electrical system; (c) determining a second power draw for a given electrical device from the set of electrical devices based on at least the determined respective first power draw for each electrical device and the received regulation-variance value; and (d) transmitting to the given electrical device a power-draw message indicating the determined second power draw. The respective first power draw may be a respective scheduled power draw of each electrical device. The second power draw may be a respective dispatched power draw of each electrical device.

In an aspect of the first embodiment, determining the respective first power draw of each electrical device may involve maximizing an energy-aggregator profit based on various factors. For example, the energy-aggregator profit may be maximized based on at least the respective first power draw for each electrical device and the amount of projected degradation in the given time period of each electrical device. As another example, the energy-aggregator profit may also be maximized based on (i) the respective first power draw for each electrical device, (ii) the respective amount of projected degradation in the given time period of each electrical device, (iii) a respective maximum additional power draw for each electrical device, (iv) a respective minimum additional power draw for each electrical device, and (v) a respective reduction in power draw available for spinning reserves for each electrical device. As yet another example, the energy-aggregator profit may be maximized subject to a set of conditions defined by at least (a) the respective first power draw of each electrical device, (b) the amount of projected degradation in the given time period of each electrical device, and (c) a respective efficiency of each electrical device. The energy-aggregator profit may be maximized based on other factors as well.

In yet another aspect of the first embodiment, determining the second power draw may involve the use of one or more regulation algorithms. Such regulation algorithms may involve an analysis of, for example, an electrical-system-regulation value received from the electrical-system operator, a responsive-reserve-regulation value received from the electrical system operator, and/or the determined first power draw. Other examples are possible as well.

A second embodiment of the disclosed methods, systems, and devices may take the form of a computing device that includes a non-transitory computer readable medium; and program instructions stored on the non-transitory computer readable medium and executable by at least one processor to cause the computing device to: (a) determine, based on at least a respective amount of projected degradation in a given time period of each electrical device from a set of electrical devices, a respective first power draw of each electrical device for the given time period, where each electrical device is coupled to an electrical system; (b) receive, from an electrical system operator, a regulation-variance value that indicates a variation from a scheduled power consumption of the electrical system; (c) determine a second power draw for a given electrical device from the set of electrical devices based on at least the determined respective first power draw for each electrical device and the received regulation-variance value; and (d) transmit to the given electrical device a power-draw message indicating the determined second power draw.

A third embodiment of the disclosed methods, systems, and devices may take the form of a physical computer-readable medium having computer executable instructions stored thereon, the instructions including: (a) instructions for determining, based on at least a respective amount of projected degradation in a given time period of each electrical device from a set of electrical devices, a respective first power draw of each electrical device for the given time period, where each electrical device is coupled to an electrical system; (b) instructions for receiving, from an electrical system operator, a regulation-variance value that indicates a variation from a scheduled power consumption of the electrical system; (c) instructions for determining a second power draw for a given electrical device from the set of electrical devices based on at least the determined respective first power draw for each electrical device and the received regulation-variance value; and (d) instructions for transmitting to the given electrical device a power-draw message indicating the determined second power draw.

These as well as other aspects and advantages will become apparent to those of ordinary skill in the art by reading the following detailed description, with reference where appropriate to the accompanying drawings.

### BRIEF DESCRIPTION OF THE DRAWINGS

FIG. 1 depicts a simplified block diagram of an example electrical system in accordance with some embodiments.

FIG. 2 depicts a simplified block diagram of an example energy-aggregator computing device in accordance with some embodiments.

FIG. 3 depicts a simplified flow chart of an example energy-optimization method in accordance with some embodiments.

FIG. 4 depicts a simplified regulation-algorithm flowchart in accordance with some embodiments.

FIG. 5 depicts an additional regulation-algorithm flowchart in accordance with some embodiments.

FIG. 6A depicts a power-draw chart in accordance with some embodiments.

FIG. 6B depicts a state-of-charge chart in accordance with some embodiments.

FIG. 7 depicts an additional power-draw chart in accordance with some embodiments.

### DETAILED DESCRIPTION

In the following detailed description, reference is made to the accompanying figures, which form a part thereof. In the figures, similar symbols typically identify similar components, unless context dictates otherwise. The illustrative embodiments described in the detailed description, figures, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are contemplated herein.

Further, certain aspects of the disclosure herein refer to the “optimization,” or some variation thereof, of the power draw of a given electrical device. It should be understood that use of such a term (i.e. “optimization,” or some variation thereof) is not mean to imply that the power draw reflects a power draw that is ideal, perfect, or desirable in all situations. Instead, such a term is used for purposes of example and explanation only to describe the example power draws that may be determined according to the various methods described herein. Therefore, use of the term “optimization,” or some variation thereof, should not be taken to be limiting.

### I. EXAMPLE ELECTRICAL SYSTEM

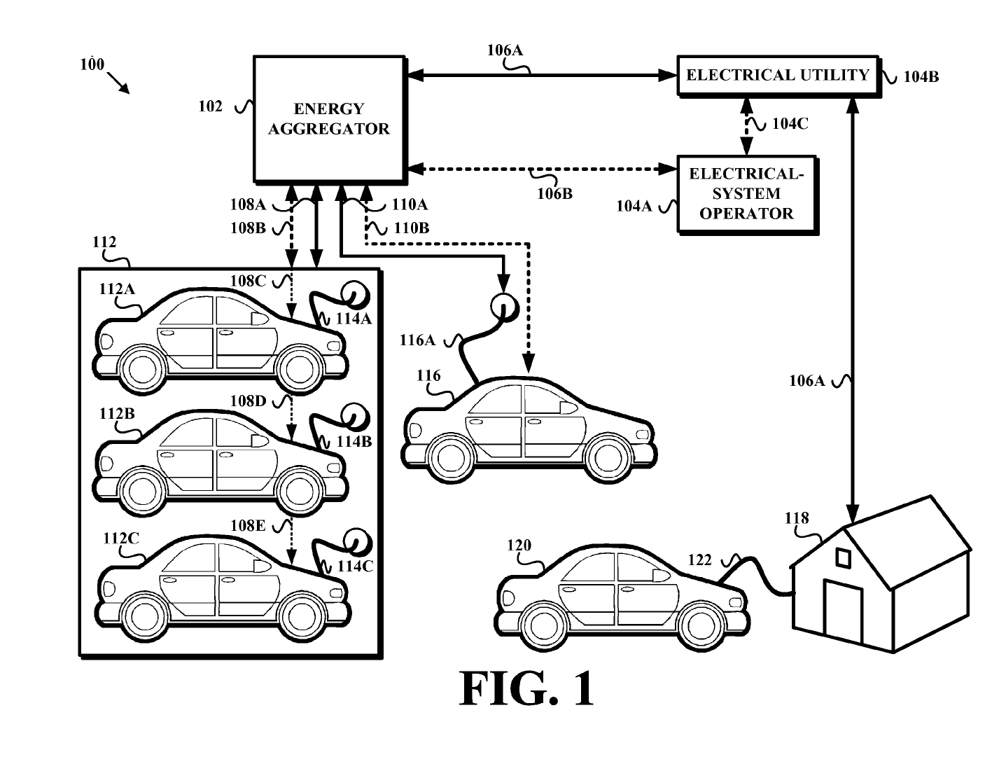

FIG. 1 depicts a simplified block diagram of an example electrical system in accordance with some embodiments. It should be understood that this and other arrangements described herein are set forth only as examples. Those skilled in the art will appreciate that other arrangements and elements (e.g., machines, interfaces, functions, orders, and groupings of functions, etc.) can be used instead and that some elements may be omitted altogether. Further, many of the elements described herein are functional entities that may be implemented as discrete or distributed components in conjunction with other components and in any suitable combination and location. Various functions described herein as being performed by one or more entities may be carried out by hardware, firmware, and/or software. For instance, various functions may be carried out by a processor executing instructions stored in memory.

As shown in FIG. 1, example electrical system 100 includes energy aggregator 102, electrical-system operator 104A, and electrical utility 104B. Electrical system 100 also includes various electric vehicles such as electric vehicles 112A-112C (shown as parked in parking facility 112), 116, and 120, and includes home 118, each of which is directly or indirectly coupled to electrical-system operator 104A and electrical utility 104B. Additional entities could be present as well or instead. For example, there could be additional electric vehicles coupled to electrical-system operator 104A and/or energy aggregator 102; furthermore, there could be additional entities coupled to, or otherwise in communication with electrical-system operator 104A and/or energy aggregator 102, including electrical devices that consume energy other than electric vehicles 112A-112C, 116, and 120. Generally, electrical-system operator 104A, electrical utility 104B, and/or energy aggregator 102 may be coupled to one or more electrical grids and thereby may participate in the provisioning of electrical-energy services to electrical devices in electrical system 100.

Energy aggregator 102 may provide electrical energy to parking facility 112 by way of electrical link 108A. In turn, parking facility 112 may distribute electrical energy provided by energy aggregator 102 to each of electric vehicles 112A-112C by way of electrical interconnects 114A-114C, respectively, which may take any suitable form such as a power outlet. As one specific example, an electrical interconnect may take the form of a Society of Automotive Engineers (SAE) J1772 compliant electrical connector. Charging of an electric vehicle that is coupled to energy aggregator 102 via a SAE compliant electrical connector may be controlled by adjusting a control-pilot signal sent by energy aggregator 102 to the electric vehicle. It should be understood, however, that a SAE compliant electrical connector is but one example of an electrical interconnect, and that other types of electrical interconnects may be used as well.

Energy aggregator 102 may provide electrical energy to individual electric vehicle 116 by way of electrical link 110A, which may be accessed by electric vehicle 116 by way of electrical interconnect 116A. Generally, the disclosure herein is directed to the bidirectional provisioning of power, and thus, according to the example shown in FIG. 1, power may flow in both directions between energy aggregator 102 to each of parking facility 112 and electric vehicle 116. That is, power may flow from energy aggregator 102 to each of parking facility 112 and electric vehicle 116. Also, power may flow from each of parking facility 112 and electric vehicle 116 to energy aggregator 102.

Energy aggregator 102 may also be communicatively coupled to parking facility 112 and electric vehicle 116 by way of, for example, communication links 108A and 110A, respectively. Parking facility 112 may then indirectly communicatively couple electric vehicles 112A-112C with energy aggregator 102 by way of communication links 108C-108E, respectively.

As such, each of energy aggregator 102, parking facility 112, and electric vehicles 112A-112C and 116 may be arranged to carry out the communication functions described herein and may therefore include a communication interface. The communication interface may include one or more antennas, chipsets, and/or other components for communicating with other entities and/or devices in electrical system 100. The communication interface may be wired and/or wireless and may be arranged to communicate according to one or more communication protocols now known (e.g., CDMA, WiMAX, LTE, IDEN, GSM, WIFI, HDSPA, among other examples) or later developed.

As shown, energy aggregator 102 may be electrically coupled to electric utility 104B by way of electrical link 106A. Further, electrical link 106A may be implemented as a bidirectional electrical link. Energy aggregator 102 may also be communicatively coupled to electrical-system operator 104A by way of communication link 106B. Further, electrical-system operator 104A may be communicatively coupled to electrical utility 104B by way of communication link 104C. As such, energy aggregator 102, electrical-system operator 104A, and electrical utility 104B may be arranged to include respective communication interfaces, such as that described above, so as to enable communications between or among themselves and/or other network entities.

Electrical utility 104B may be directly coupled to various other entities in electrical system 100, including, ultimately, electrical devices that are consumers of electrical energy. For example, electrical utility 104B may be connected to home 118 by way of electrical link 106A. In turn, home 118 may distribute electrical energy provided by electrical utility 104B to other electrical devices, such as electrical vehicle 120, by way of electrical interconnect 122.

Energy aggregator 102 may be any entity that carries out the energy-aggregator functions described herein. For example energy aggregator 102 may be any private or public organization, or combination thereof, that is generally authorized to connect to the electrical grid and therefore participate in electrical system 100.

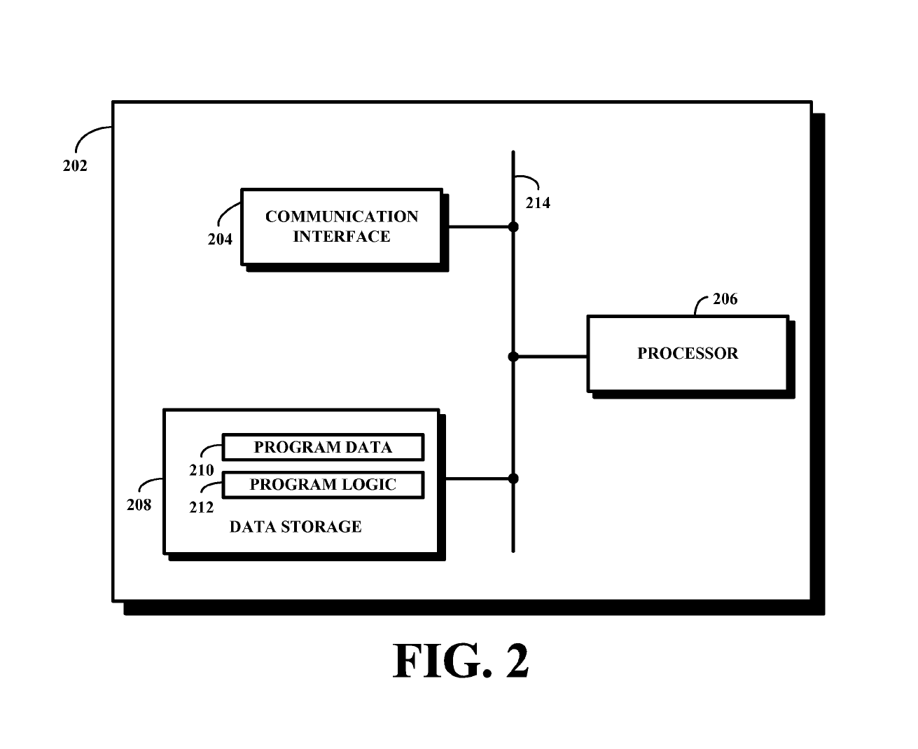

Generally, energy aggregator 102 may include any necessary electrical system equipment, devices, or other elements necessary to both distribute electrical energy, as needed, and communicate with other entities and/or devices in electrical system 100. As an example, energy aggregator 102 may include a computing device, such as computing device 202 shown in FIG. 2. As shown, energy-aggregator computing device 202 may include, without limitation, a communication interface 204, processor 206, and data storage 208, all of which may be communicatively linked together by a system bus, network, and/or other connection mechanism 214.

Communication interface 204 typically functions to communicatively couple energy aggregator 102 to other devices and/or entities in electrical system 100. As such, communication interface 204 may include a wired (e.g., Ethernet, without limitation) and/or wireless (e.g., CDMA and/or Wi-Fi, without limitation) communication interface, for communicating with other devices and/or entities. Communication interface 204 may also include multiple interfaces, such as one through which energy-aggregator computing device 202 sends communication, and one through which energy-aggregator computing device 202 receives communication. Communication interface 204 may be arranged to communicate according to one or more types of communication protocols mentioned herein and/or any others now known or later developed.

Processor 206 may include one or more general-purpose processors (such as INTEL processors or the like) and/or one or more special-purpose processors (such as digital-signal processors or application-specific integrated circuits). To the extent processor 206 includes more than one processor, such processors could work separately or in combination. Further, processor 206 may be integrated in whole or in part with wireless-communication interface 204 and/or with other components.

Data storage 208, in turn, may include one or more volatile and/or non-volatile storage components, such as magnetic, optical, or organic memory components. As shown, data storage 208 may include program data 210 and program logic 212 executable by processor 206 to carry out various energy-aggregator functions described herein. Although these components are described herein as separate data storage elements, the elements could just as well be physically integrated together or distributed in various other ways. For example, program data 210 may be maintained in data storage 208 separate from program logic 212, for easy updating and reference by program logic 212.

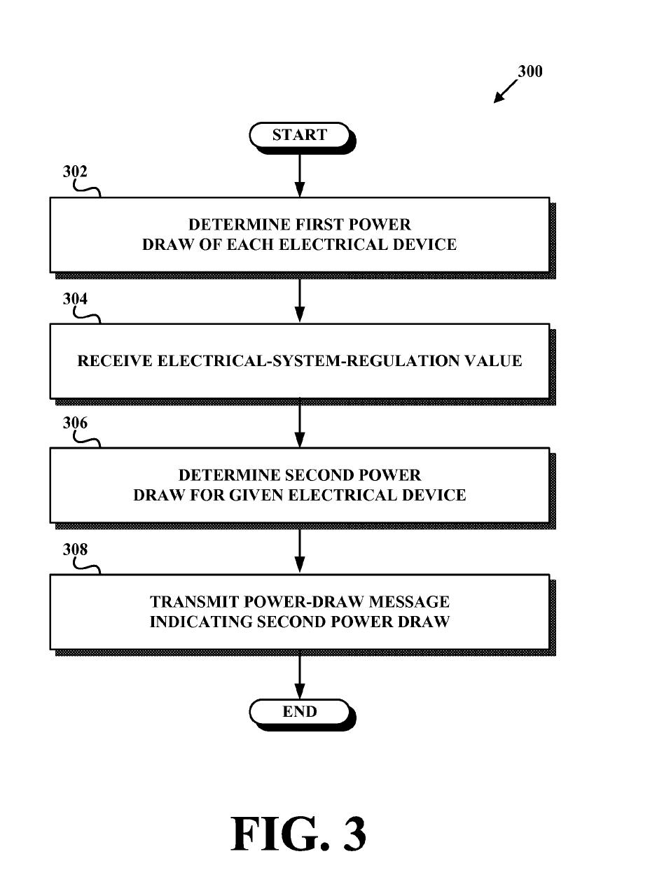

Program data 210 may include various data used by energy-aggregator computing device 202 in operation. As an example, program data 210 may include information pertaining to various other devices and/or entities in electrical system 100 such as, without limitation, any of electrical system operator 104A, electrical utility 104B, parking facility 112, and/or electric vehicles 112A-112C and 116. Similarly, program logic 212 may include any additional program data, code, or instructions necessary to carry out the energy-aggregator functions described herein. For example, program logic 212 may include instructions executable by processor 206 for causing computing device 202 to carry out any of those functions described herein with respect to FIGS. 3-7.

### II. EXAMPLE FUNCTIONS

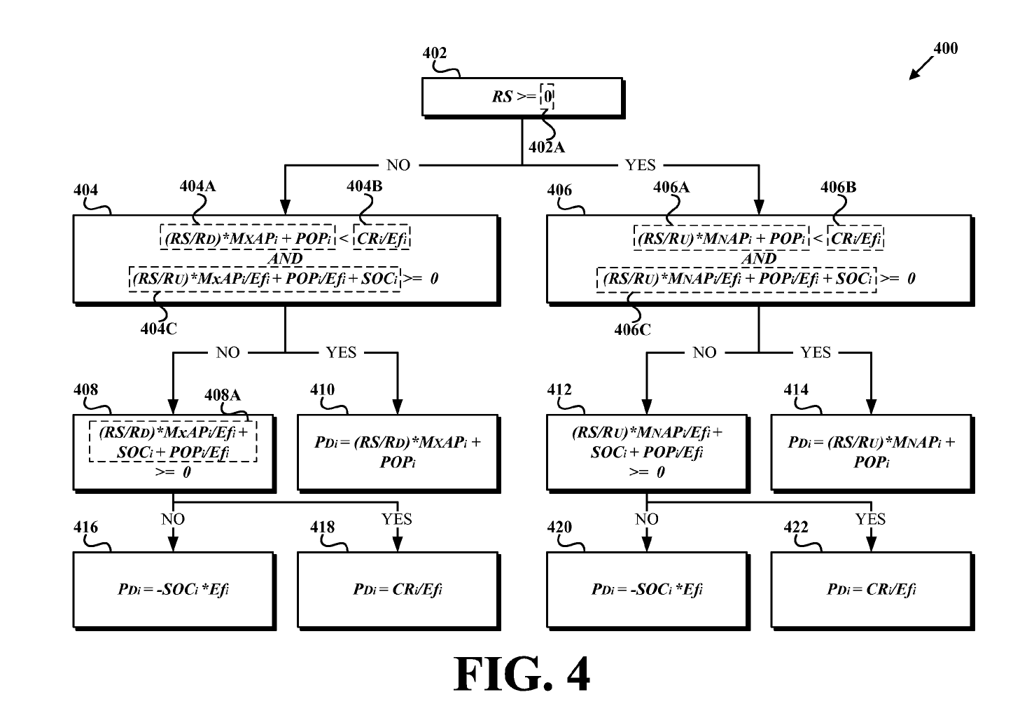

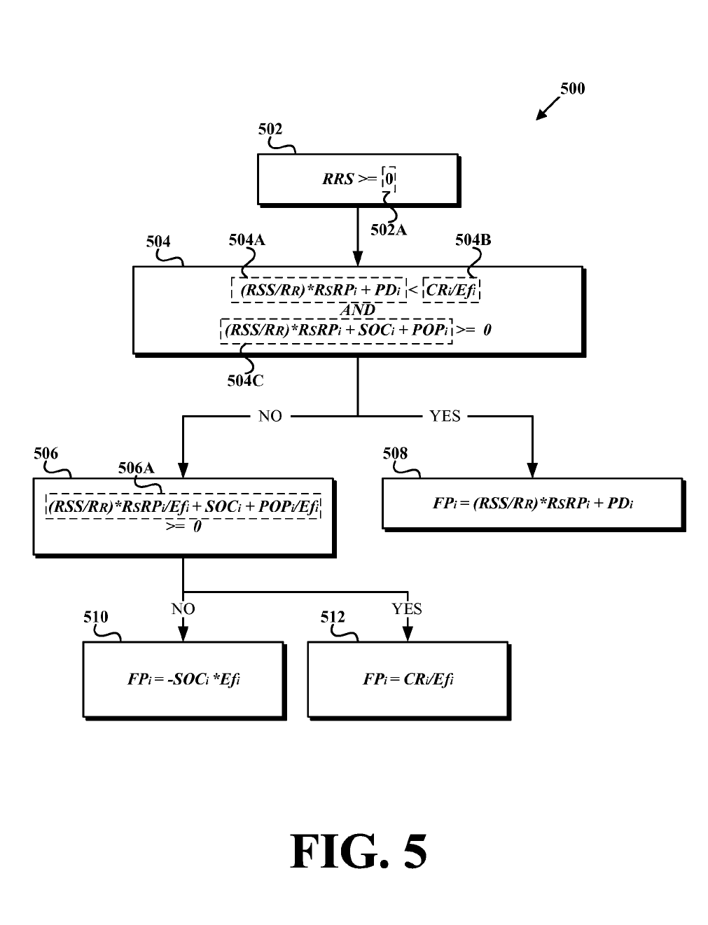

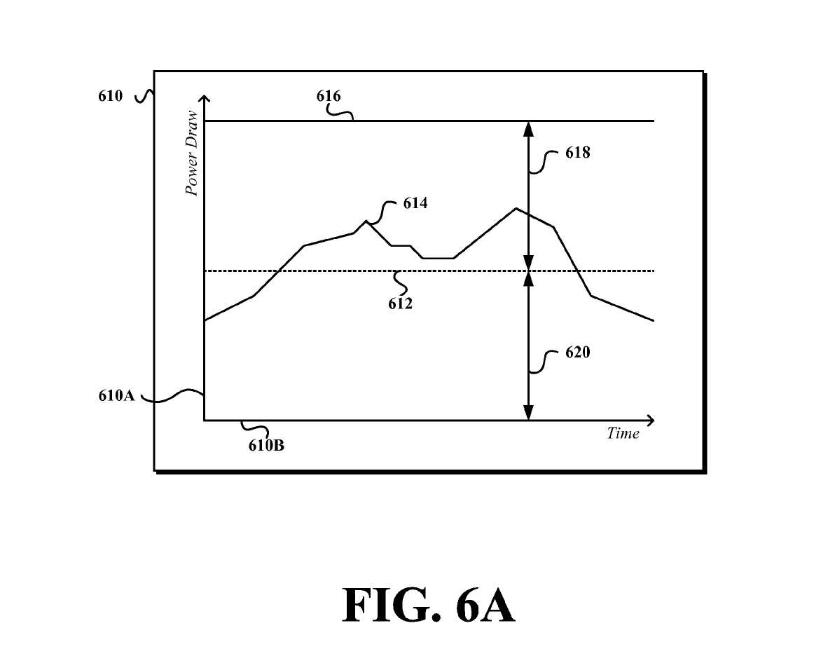

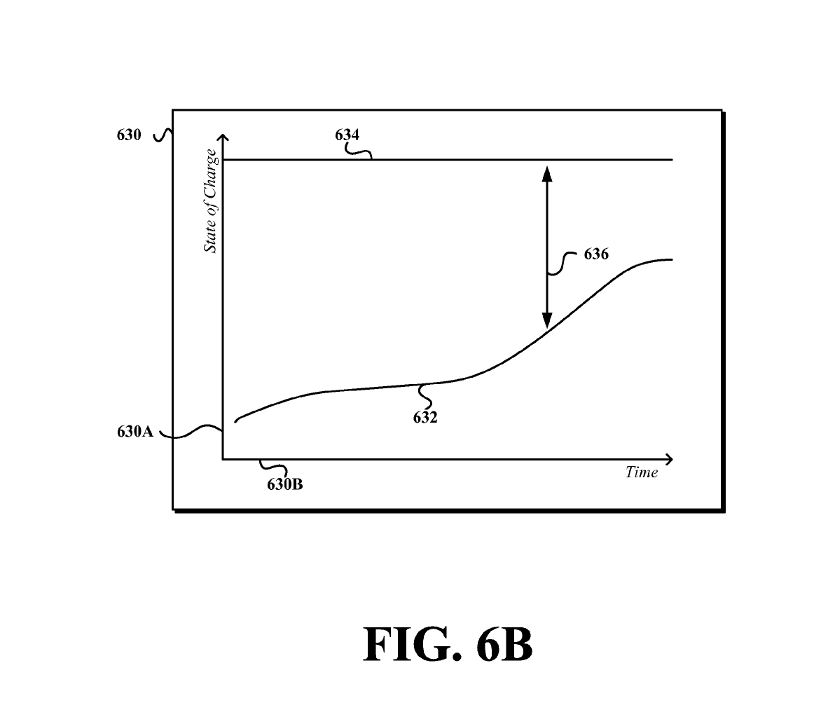

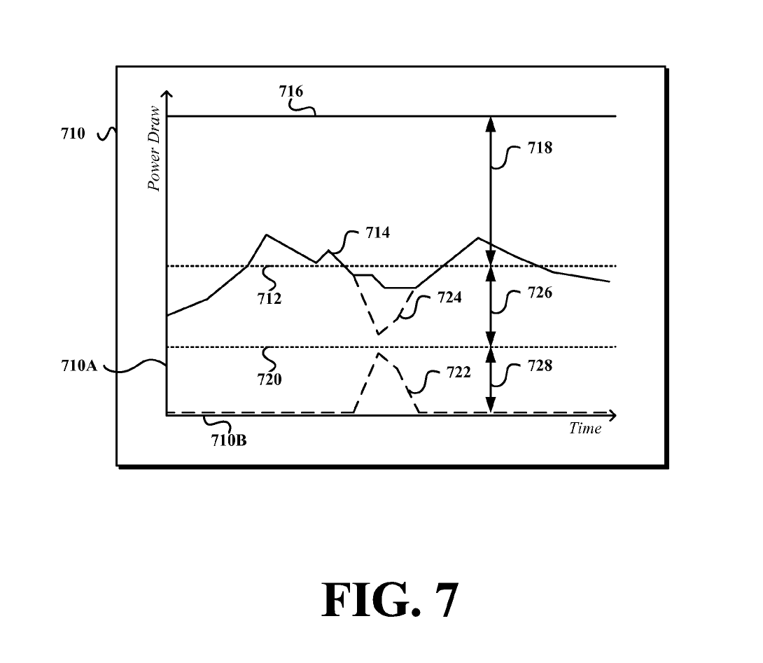

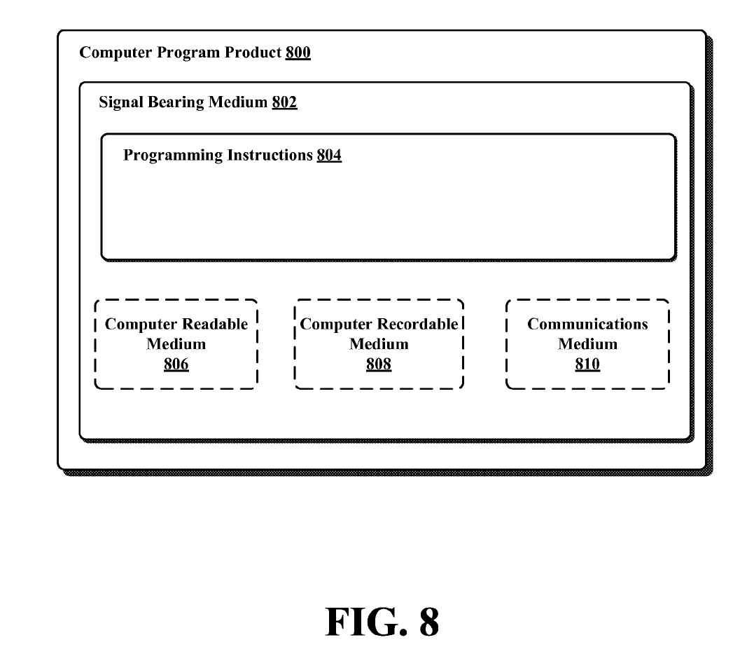

FIGS. 3-5 are generally directed to an example method for bidirectional control of aggregated electrical devices such as electric vehicles, which includes the control of ancillary services. More specifically, FIG. 3 depicts a simplified flow chart of an example energy-optimization method, method 300, in accordance with some embodiments. Correspondingly, FIG. 4 depicts a simplified regulation-algorithm flowchart in accordance with some embodiments, including embodiments that implement aspects of method 300. FIG. 5 depicts an additional simplified flowchart in accordance with some embodiments, including embodiments that implement aspects of method 300. FIG. 6A depicts a power-draw chart, and FIG. 6B depicts a state-of-charge chart, in accordance with some embodiments, including embodiments that implement aspects of method 300. And FIG. 7 depicts an additional power-draw chart in accordance with some embodiments, including embodiments that implement aspects of method 300.

Generally, the methods and functions described herein may be carried out in an electrical system, such as example electrical system 100, by an energy aggregator, such as energy aggregator 102. Again, however, it should be understood that example electrical system 100 is set forth for purposes of example and explanation only, and should not be taken to be limiting. The present methods and functions may just as well be carried out in other electrical systems having other arrangements.

As noted above, the methods and systems described herein may enable energy aggregator 102 to efficiently control respective power draws of various electrical devices in electrical system 100. And because the disclosure herein contemplates bidirectional control of various electrical devices, energy aggregator 102 may cause the electrical devices to increase their respective power draws, decrease their respective power draws, and/or discharge energy back into electrical system 100. Before turning to a more detailed description of such methods and systems, a brief summary of some of the nomenclature used in the remainder of the disclosure is provided, for convenience.

a. Nomenclature

The variables in the table set forth below may be referred to in the remainder of this disclosure for purposes of explanation of the methods disclosed herein. However, it should be understood that reference to such variables is for purposes of example and explanation only, and that the listing of such variables below is for purposes of convenience only, and therefore neither the variables themselves, nor the listing of the variables below, shall be taken to be limiting.

| | |
|---|---|
| BatCᵢ | The battery replacement cost of the i^{th} ED. |
| ρ | Penalty fee that the energy aggregator must pay the |
| | customer per kWh for failure to meet the desired |
| | minimum-allowable state of charge. |
| C | Cost to the energy aggregator. |
| Compᵢ(t) | Compensation factor of the i^{th} ED to account for |
| | unplanned departures. |
| CRᵢ | Charge remaining to be supplied to the i^{th} ED. |
| DCᵢ | The degradation cost to the battery from discharging plus |
| | a compensation amount to ensure the aggregator cannot |
| | take advantage of charging and discharging efficiencies |
| | to charge the customer more. |
| Degᵢ(t) | An epigraph variable to model battery degradation. |
| Depᵢ(t) | Probability that the i^{th} ED will depart unexpectedly in |
| | hour t. |
| E[ ] | The expected value function. |
| Efᵢ | Efficiency of the i^{th} ED's battery charger. |
| Ex_{D} | Expected percentage of regulation down capacity |
| | dispatched each hour. |
| Ex_{R} | Expected percentage of responsive reserve capacity |
| | dispatched each hour. |
| Ex_{U} | Expected percentage of regulation up capacity dispatched |
| | each hour. |
| EVPer(t) | Expected percentage of the EDs remaining to perform |
| | V2G at hour t. |
| FPᵢ | Final power draw of the i^{th} ED combining the effects of |
| | regulation and responsive reserves. |
| In | Income of the energy aggregator. |
| L(t) | System net load (load minus renewables) at time t. |
| M_{C, i} | Maximum charge capacity of the i^{th} ED. |
| Mk | The price of energy charged to the customer. |
| MnAPᵢ | Minimum additional power draw of the i^{th} ED. |
| Mn_{L} | Minimum day-ahead forecasted net load. |
| MPᵢ(t) | Maximum possible power draw of i^{th} ED at time t. If the |
| | ED is not plugged in, this value is 0. |
| MxAPi | Maximum additional power draw of the i^{th} ED. |
| Mx_{L} | Maximum day-ahead forecasted net load. |
| P(t) | Energy price at time t. |
| PDᵢ | Power draw of the i^{th} ED. |
| POPᵢ | Preferred (target) operating point of the i^{th} ED. |
| Pr[ ] | Probability of dispatch for ancillary services. |
| P_{RD}(t) | Forecasted price of regulation down for time t. |
| P_{RR}(t) | Forecasted price of responsive reserves for time t. |
| P_{RU}(t) | Forecasted price of regulation up for time t. |
| R_{D} | Regulation down capacity of the aggregator. |
| R_{R} | Responsive reserve capacity of the energy aggregator. |
| RRS | Responsive reserve signal provided to the aggregator. |
| RS | Electrical-system-regulation value provided to the energy |
| | aggregator. |
| RsRPᵢ | Reduction in power draw available for spinning reserves |
| | of the i^{th} ED. |
| R_{U} | Regulation up capacity of the energy aggregator. |
| SOCᵢ | Current state of charge of the i^{th} ED. |
| SOC_{I, i} | Initial state of charge of the i^{th} ED. |
| T | Ending time of the daily scheduling. |
| Tripᵢ(time) | Reduction in SOC that results from the evening commute |
| | trip home on a weekday or the second daily trip on the |
| | weekend. When looking ahead if the commute will occur |
| | after the hours considered, Tripᵢ(time) is 0. If the teip |
| | occurs before the hour considered, Tripᵢ(time) is the |
| | energy used on the trip. If the trip has already occurred, |
| | Tripᵢ(time) is 0. |
| T_{trip, i} | Time that the i^{th} ED makes its second trip of the day. On |
| | a weekday this is the commute from work to home. On |
| | the weekend this is simply the second excursion which |
| | ends when the ED returns home. |

b. Energy Optimization

With reference to FIG. 3, method 300 begins at block 302 when the energy aggregator determines, based on at least a respective amount of projected degradation in a given time period of each electrical device from a set of electrical devices, a respective first power draw of each electrical device for the given time period, where each electrical device is coupled to an electrical system. At block 304, the energy aggregator receives, from an electrical system operator, a regulation-variance value that indicates a variation from a scheduled power consumption of the electrical system. At block 306, the energy aggregator determines a second power draw for a given electrical device from the set of electrical devices based on at least the determined respective first power draw for each electrical device and the received regulation-variance value. And at block 308, the energy aggregator transmits to the given electrical device a power-draw message indicating the determined second power draw.

Each of these blocks is discussed further below.

i. Determine First Power Draw of Each Electrical Device

At block 302, energy aggregator 102 determines, based on at least a respective amount of projected degradation in a given time period of each electrical device from a set of electrical devices such as set of electric vehicles 112A-112C, a respective first power draw of each electrical device for the given time period, where each electrical device is coupled to an electrical system 100.

Generally, the respective first power draw of each electrical device may be a respective scheduled power draw of each electrical device. Such a respective scheduled power draw is commonly referred to as a “Preferred Operating Point (POP)” in energy-aggregation contexts. As such, reference is made herein to Preferred Operating Points, and in particular to variables associated with a Preferred Operating Points, such as POPᵢ. However, it should be understood that such references are for purposes of example and explanation only and should not be taken to be limiting. Further, the terms “first power draw,” “scheduled power draw,” and “preferred operating point” may be used herein, at times, interchangeably. POPᵢ may be positive (the electrical device scheduled to receive power) or negative (the electrical device scheduled to provide power to the electrical system). Note that the first power draw and the second power draw may also be positive and/or negative.

For purposes of example and explanation, an example technique for selecting a first power draw (or scheduled power draw) for each electrical device, in accordance with block 302, is described below. The example technique is an example optimal charging algorithm that is referred to herein, without limitation, as an “optimal selection algorithm.” As described above, the use of the term “optimal” is for purposes of example and explanation only and should not be taken to be limiting.

According to an example optimal selection algorithm, determining, based on at least the respective amount of projected degradation in the given time period of each electrical device from the set of electrical devices, the respective first power draw of each electrical device for the given time period, may involve maximizing an energy-aggregator profit based on at least the respective first power draw for each electrical device and the amount of projected degradation in the given time period of each electrical device. The energy-aggregator profit may be determined as a function of the income of the energy aggregator (In), cost to the energy aggregator (C), or a difference thereof (In −C).

The energy-aggregator profit may be maximized based on at least the respective first power draw for each electrical device and the amount of projected degradation in the given time period of each electrical device (Degᵢ(t)) and at least one additional consideration. One example of such an additional consideration is a respective maximum additional power draw for each electrical device (MxAPi). Another example of such an additional consideration is a respective minimum additional power draw for each electrical device (MnAPᵢ). Yet another example of such an additional consideration is a respective reduction in power draw available for spinning reserves for each electrical device (RsRPᵢ). The energy-aggregator profit may be maximized based on the respective first power draw for each electrical device and one or more of each such additional considerations. Maximization of the energy-aggregator profit according to all such conditions is represented below by Equation 1.

maximize_{POP}_{ᵢ}_{(t),MxAP}_{ᵢ}_{(t),MnAP}_{ᵢ}_{(t),RsRP}_{ᵢ}_{(t),Deg}_{ᵢ}₍ₜ₎In−C (1)

In general, the income of the energy aggregator (In) may be determined based on at least a regulation-service income and an energy-supply-service income. In an example, the income of the energy aggregator (In) may be determined based on the sum of the regulation-service income and the energy-supply-service income. The regulation-service income may be defined by the summation of (i) a forecasted price of regulation up for time t (P_{RU}(t)) multiplied by a regulation up capacity of the energy aggregator for time t (R_{U}(t)), (ii) a forecasted price of regulation down for time t (P_{RD}(t)) multiplied by a regulation down capacity of the energy aggregator for time t (R_{D}(t)), and a forecasted price of responsive reserves for time t (P_{RR}(t)) multiplied by a responsive reserve capacity of the energy aggregator (R_{R}(t)), over time. The energy-supply-service income may be defined by (i) a summation of an expected value of a final power draw of each electrical device (E[FPᵢ(t)]) over time and all electrical devices multiplied by the price of energy charged by the energy aggregator to the customer (Mk) and (ii) a summation of an expected value of the final power draw of each electrical device (E[FPᵢ(t)]) multiplied by an energy price for time t P(t) over time and all electrical devices, if the expected value of the final power draw of each electrical device (E[FPᵢ(t)]) is less than or equal to 0. Such an income of the energy aggregator (In) is represented below by Equation 2.

In =Σₜ(P_{RU}(t)R_{U}(t)+P_{RD}(t)R_{D}(t)+P_{RR}(t)R_{R}(t))+MkΣᵢΣₜ(E[FPᵢ(t)])+MkΣᵢΣₜ(E[FPᵢ(t)]P(t)) if E[FPᵢ(t)]≦0 (2)

The regulation up capacity of the energy aggregator for time t (R_{U}(t)) may be defined as the summation of the respective minimum additional power draw for each electrical device (MnAPᵢ), as represented below by Equation 3.

R_{U}(t)=Σᵢ₌₁^{devices}MnAPᵢ(t) (3)

The regulation down capacity of the energy aggregator for time t (R_{D}(t)) may be defined as the summation of the respective maximum additional power draw for each electrical device (MxAPᵢ), as represented below by Equation 4.

R_{D}(t)=Σᵢ₌₁^{devices}MxAPᵢ(t) (4)

The responsive reserve capacity of the energy aggregator for time t (R_{R}(t)) may be defined as the summation of a reduction in power draw available for spinning reserves for each electrical device (RsRPᵢ), as represented below by Equation 5.

R_{R}(t)=Σᵢ₌₁^{devices}RsRPᵢ(t) (5)

The expected value of the final power draw of each electrical device (E[FPᵢ(t)]) may be further defined as a respective maximum additional power draw for each electrical device (MxAPi) multiplied by an expected percentage of regulation down capacity dispatched (Ex_{D}) plus the first power draw minus a respective minimum additional power draw for each electrical device (MnAPᵢ) multiplied by an expected percentage of regulation up capacity dispatched (Ex_{U}) minus the reduction in power draw available for spinning reserves for each electrical device (RsRPᵢ) multiplied by an expected percentage of responsive reserve capacity dispatched each hour (Ex_{R}). Such an energy received by each electrical device over time (E[FPᵢ(t)]) is represented below by Equation 6.

$$\begin{matrix}( E [ {FP}_{i} ( t ) ] ) = {MxAP}_{i} ( t ) {Ex}_{D} + {POP}_{i} ( t ) - {MnAP}_{i} ( t ) {Ex}_{U} - {RsRP}_{i} ( t ) {Ex}_{R} \\ Where \text{:} & ( 6 ) \\ {Ex}_{D} = \frac{{\int }_{{RS}_{min}}^{0} RS \cdot Pr [ R S ] \cdot d RS}{{\int }_{{RS}_{min}}^{0} RS \cdot d RS} & ( 7 ) \\ {Ex}_{U} = \frac{{\int }_{0}^{{RS}_{max}} RS \cdot Pr [ RS ] \cdot d RS}{{\int }_{0}^{{RS}_{max}} RS \cdot d RS} & ( 8 ) \\ {Ex}_{R} = \frac{{\int }_{0}^{{RRS}_{max}} RRS \cdot Pr [ RRS ] \cdot d RRS}{{\int }_{0}^{{RRS}_{max}} RRS \cdot d RRS} & ( 9 )\end{matrix}$$

In general, the cost to the energy aggregator (C) may be determined based on at least a respective expected value of the final power draw of each electrical device (E[FPᵢ(t)]), a cost of energy P(t), a respective projected degradation cost of each electrical device (DCᵢ), and a respective efficiency of each electrical device (Efᵢ). In an example, the cost of the energy aggregator (C) may be determined based on a summation of an expected value of the final power draw of each electrical device (E[FPᵢ(t)]) multiplied by an energy price for time t P(t), over time and all electrical devices, plus a summation of the projected degradation cost of each electrical device (DCᵢ), multiplied by an inverse of the final power draw of each electrical device (E[FPᵢ(t)]), divided by the respective efficiency of each electrical device (Efᵢ), over time and all electrical devices. Such a cost of the energy aggregator (C) is represented below by Equation 10.

C=ΣᵢΣₜ(E[FPᵢ(t)]P(t))+ΣᵢΣₜ(DCᵢE[FPᵢ⁻(t)]/Efᵢ) (10)

Note that the first term in (10) is zero unless E[FPᵢ(t)]>0. The second term is also zero unless E[FPᵢ⁻(t)]<0.

Further, the expected value of the reduction portion of the final power draw and the degradation costs may be given by Equations 11 and 12, respectively.

$$\begin{matrix}E [ {FP}_{i}^{-} ( t ) ] = {POP}_{i} ( t ) - {MnAP}_{i} {Ex}_{U} - {RsRP}_{i} ( t ) {Ex}_{R} & ( 11 ) \\ {DC}_{i} = 0.042 ( \frac{{BatC}_{i}}{5000} ) + \frac{1 - {Ef}_{i}^{2}}{{Ef}_{i}} Mk & ( 12 )\end{matrix}$$

The first term in Equation 12 generally corresponds to the replacement cost of a battery, normalized by known battery replacement costs recognized by those of ordinary skill in the art. However, it should be understood that other replacement costs may be used as well. This normalized cost is multiplied by the degradation cost of a kWh of energy throughput that is recognized by those of ordinary skill in the art. However, it should be understood that this value is chemistry specific, and it could be adapted for any battery chemistry that may be used.

The second term in Equation 12 is an efficiency balancing term multiplied by the aggregator price of energy to account for the differences in energy delivered to and taken from the electric device compared to what is measured by the energy aggregator 102. For example, if the energy aggregator 102 charges 4 kWh into the electric device, with a 90% charging efficiency then the customer may be billed for 4/0.9=4.44 kWh. If the energy aggregator 102 then discharges 4 kWh from the electric device with a 90% discharge efficiency, then the customer is paid for 4*0.9=3.6 kWh.

Further, since an electric device, such as an electric vehicle, might disconnect from the electrical system, it may be desirable for the energy aggregator to under-schedule capacity and then over-dispatch when a given electric device disconnects. This may generally help compensate for the capacity lost when the given electric device disconnects. Such a compensation formula may be given by Equation 13.

$${Comp}_{i} ( t ) = 1 + \frac{{Dep}_{i} ( t )}{1 - {Dep}_{i} ( t )} \qquad ( 13 )$$

In general, maximizing the energy-aggregator profit may be subject to any one or more of a number of various conditions. Such conditions may be defined by various combinations (or formulations) of variables relevant to the operation of energy aggregator 102. As one example, maximizing the energy-aggregator profit may be subject to a set of conditions defined by at least the respective first power draw of each electrical device (POPᵢ(t)), the amount of projected degradation in the given time period of each electrical device (Degᵢ(t)), and a respective efficiency of each electrical device (Efᵢ). For instance, an example condition may be that the respective first power draw of each electrical device is greater than or equal to the inverse of a respective maximum possible power draw of each electrical device (MPᵢ). Such an example condition is represented below by Equation 14.

POPᵢ(t)≧−MPᵢ(t) (14)

Maximizing the energy-aggregator profit may be subject to any one or more of a number of additional various conditions defined by various combinations (or formulations) of variables relevant to the operation of energy aggregator 102. As represented by the equations above and below, for example, such additional considerations may be further defined by a respective expected value of the final power draw of each electrical device (E[FPᵢ(t)]), a respective projected degradation cost of each electrical device DCᵢ, a respective initial state of charge of each electrical device SOC_{I,i}, a reduction in a state of charge associated with a trip Tripᵢ(time), a respective maximum additional power draw for each electrical device MxAPi, a respective minimum additional power draw for each electrical device MnAPᵢ, a respective reduction in power draw available for spinning reserves for each electrical device RsRPᵢ, a respective maximum charge capacity of each electrical device M_{C,i}, a respective maximum possible power draw of each electrical device MPᵢ(t), a maximum day-ahead forecasted net load of the electrical system Mx_{L}, a minimum day-ahead forecasted net load of the electrical system Mn_{L}, and an actual net load of the electrical system L(t). Further examples of such conditions are represented below by Equations 15-29.

$$\begin{matrix}( {\sum }_{t = 1}^{time} ( E [ {FP}_{i} ( t ) ] {Comp}_{i} ( t ) + {ρ}_{i} ( t ) ) {Ef}_{i} + {SOC}_{I , i} - {Trip}_{i} ( time ) ) \leq {M}_{Ci} \\ ∀ i , time & ( 15 ) \\ ( {\sum }_{t = 1}^{time} ( E [ {FP}_{i} ( t ) ] {Comp}_{i} ( t ) + {ρ}_{i} ( t ) ) {Ef}_{i} + S O {C}_{I , i} - {Trip}_{i} ( time ) ) \geq 0 \\ ∀ i , time & ( 16 ) \\ ( {\sum }_{t = 1}^{time} ( E [ {FP}_{i} ( t ) ] {Comp}_{i} ( t ) + {ρ}_{i} ( t ) ) {Ef}_{i} + {SOC}_{I , i} - {Trip}_{i} ( time ) ) \geq 0.99 {M}_{Ci} \\ ∀ i , time & ( 17 ) \\ ( {MxAP}_{i} ( 1 ) + {POP}_{i} ( 1 ) ) {Comp}_{i} ( 1 ) {Ef}_{i} + {SOC}_{I , i} \leq {M}_{Ci} \\ ∀ i & ( 18 ) \\ ( {POP}_{i} ( 1 ) - {MnAP}_{i} ( 1 ) - {RsRP}_{i} ( 1 ) + {ρ}_{i} ( 1 ) {Comp}_{i} ( 1 ) {Ef}_{i} + {SOC}_{I , i} ) \geq 0 \\ ∀ i & ( 19 ) \\ ( {POP}_{i} ( 1 ) - {MnAP}_{i} ( 1 ) - {RsRP}_{i} ( 1 ) + {ρ}_{i} ( 1 ) {Comp}_{i} ( 1 ) {Ef}_{i} + S O {C}_{I , i} ) \geq {Trip}_{i} \\ ∀ i & ( 20 ) \\ ( {MxAP}_{i} ( t ) + {POP}_{i} ( t ) ) {Comp}_{i} ( t ) \leq {MP}_{i} ( t ) \\ ∀ i & ( 21 ) \\ {MnAP}_{i} ( t ) \leq {POP}_{i} ( t ) + {MP}_{i} ( t ) \\ ∀ i & ( 22 ) \\ {RsRP}_{i} ( t ) \leq {POP}_{i} ( t ) + {MP}_{i} ( t ) - {MnAP}_{i} ( t ) \\ ∀ i & ( 23 ) \\ {MxAP}_{i} ( t ) \geq 0 \\ ∀ i & ( 24 ) \\ {MnAP}_{i} ( t ) \geq 0 \\ ∀ i & ( 25 ) \\ {RsRP}_{i} ( t ) \geq 0 \\ ∀ i & ( 26 ) \\ {Deg}_{i} ( t ) \geq 0 \\ ∀ i & ( 27 ) \\ {Deg}_{i} ( t ) \geq {DC}_{i} E [ {FP}_{i}^{-} ( t ) ] {Comp}_{i} ( t ) / {Ef}_{i} \\ ∀ i & ( 28 ) \\ {\sum }_{i}^{devices} {POP}_{i} ( t ) \leq \frac{{Mx}_{L} - L ( t )}{{Mx}_{L} - {Mn}_{L}} {\sum }_{i}^{devices} {MP}_{i} ( t ) \\ ∀ t & ( 29 )\end{matrix}$$

Further, the percentage of total electrical devices remaining connected to the electrical system in a particular hour may be represented by Equation 30.

$$EVPer ( t ) = \{ \begin{matrix}1 - {\sum }_{time = 1}^{t} {\sum }_{i} {Dep}_{i} ( time ) & if t < {T}_{trip , i} \\ 1 - {\sum }_{time = {T}_{trip}}^{t} {\sum }_{i} {Dep}_{i} ( time ) & if t \geq {T}_{trip , i}\end{matrix} \\ ∀ i \qquad ( 30 )$$

And, therefore, the income and cost of the energy aggregator may be represented by Equations 31 and 32.

$$\begin{matrix}In = {\sum }_{t} ( ( {P}_{RU} ( t ) {R}_{U} ( t ) + {P}_{RD} ( t ) {R}_{D} ( t ) + {P}_{RR} ( t ) {R}_{R} ( t ) ) EVPer ( t ) ) + Mk {\sum }_{i} {\sum }_{t} ( E [ {FP}_{i} ( t ) ] EVPer ( t ) ) & ( 31 ) \\ C = {\sum }_{i} {\sum }_{t} ( E [ {FP}_{i} ( t ) ] EVPer ( t ) P ( t ) ) + {\sum }_{i} {\sum }_{t} ( {Deg}_{i} ( t ) ) & ( 32 )\end{matrix}$$

Further, it is of note that pᵢ(t) (appearing in various equations above), the penalty fee that the energy aggregator must pay for battery degradation and energy losses from round-trip efficiency, may be represented by Equation 33.

$${ρ}_{i} ( t ) = ( \frac{{Deg}_{i} ( t )}{{DC}_{i}} ) \frac{1 - {Ef}_{i}^{2}}{{Ef}_{i}} \qquad ( 33 )$$

ii. Receive Electrical-System-Regulation Value

At block 304, energy aggregator 102 receives, from an electrical system operator, a regulation-variance value that indicates a variation from a scheduled power consumption of the electrical system. For example, electrical-system operator 104A may provide a regulation-variance value that is an electrical-system-regulation value (RS) to energy aggregator 102 by way of communication link 106B. Additionally or alternatively, electrical-system operator may provide a regulation-variance value that is a responsive-reserve-regulation value (RRS) to energy aggregator 102 by way of communication link 106B. Each of electrical-system-regulation value (RS) and responsive-reserve-regulation value (RRS) are discussed further below.

Electrical-system operator 104A may be arranged to monitor the state of electric resources of electrical utility 104B and compare the state of such electric resources to a pre-determined schedule of electric resources. In the event that the state of such electric resources varies from the predetermined schedule of electric resources, electrical-system operator 102A may indicate as much by providing an electrical-system-regulation value (RS) to energy aggregator 102 by way of communication link 106B.

As one example, in the event that the amount of power consumed by a certain segment of an electrical grid is below that which was scheduled for the electrical grid, electrical-system operator 104A may indicate that variation from schedule to energy aggregator 102 with the expectation that energy aggregator 102 will provide a regulation-down service (e.g., consume excess energy resources available from electrical utility 104B by consuming more energy resources than energy-aggregator 102 was originally scheduled to consume), if possible. As another example, in the event that the power consumed by a certain segment of an electrical grid is above that which was scheduled for the electrical grid, electrical-system operator 104A may indicate that variation from schedule to energy aggregator 102 with the expectation that energy aggregator 102 will provide a regulation-up service (e.g., consume less energy resources than energy-aggregator 102 was originally scheduled to consume, or cause electrical devices to discharge and thereby provide energy resources to the electrical system), if possible.

Further, note that electrical systems may be arranged such that an electrical-system operator associated with the electrical system has access to responsive reserves—or extra generating capacity that is available in a short interval of time to meet demand in case, for example, a generator goes down or there is another disruption in the electrical supply of the electrical system. Such responsive reserves may be divided into spinning reserves (i.e., extra generating capacity that is available by increasing the power output of generators that are already connected to the power system), and supplemental reserves (i.e., extra generating capacity that is not currently connected to the electrical system but can be brought online after a short delay). Generally, such responsive reserves provide a relatively extreme regulation-up service to the electrical system.

Aggregated electrical devices that are under bidirectional control are able to provide a regulation-up service similar to that provided by responsive reserves by decreasing the amount of energy consumed by the aggregated electrical devices or by causing at least some of the electrical devices to discharge their respective energy into the electrical system. That is, by decreasing the energy consumed by the aggregated electrical devices, the aggregation may decrease the electrical burden of the electrical system and thereby make additional energy resources available to other electrical-system entities. Or, by discharging energy into the electrical system, the aggregation may directly provide additional energy resources to the electrical system. An energy aggregator, such as energy aggregator 102, may play a critical role in implementing such a responsive reserve function for an aggregation of electrical devices. This role is discussed in further detail below, including with respect to a discussion of block 306.

iii. Determine Second Power Draw for Given Electrical Device

At block 306, energy aggregator 102 determines a second power draw for a given electrical device from the set of electrical devices based on at least the determined respective first power draw for each electrical device and the received regulation-variance value.

Generally, the second power draw for the given electrical device may be a dispatched power draw for the given electrical device. That is, energy aggregator 102 may direct the given electrical device, perhaps via one of communication links 108B, 110B, or another similar communication link, to operate at the second power draw.

FIG. 4 depicts simplified regulation-algorithm flowchart 400 in accordance with some embodiments. Regulation-algorithm flowchart 400 represents an algorithm corresponding to when energy-aggregator 102 receives a regulation-variance value that is an electrical-system regulation value (RS). At decision point 402 energy aggregator 102 determines whether the electrical-system regulation value (RS) exceeds system-regulation-value threshold 402A. Note that, in the example shown in FIG. 4, system-regulation-value threshold 402A is shown as being equal to “0.” However, this is for purposes of example and explanation only, and should not be taken to be limiting.

If, at decision point 402, energy aggregator 102 determines that the electrical-system-regulation value (RS) exceeds system-regulation-value threshold 402A, then energy aggregator 102 may proceed to decision point 406 where energy aggregator 102 may determine whether first regulation value 406A is less than second regulation value 406B, where first regulation value 406A is a ratio of the system-regulation value (RS) and a regulation-up capacity of the energy aggregator (R_{U}), multiplied by a minimum additional power draw of the given electrical device (MnAPi), plus the first power draw of the given electrical device (POPᵢ), and where second regulation value 406B is a ratio of a charge remaining to be supplied to the given electrical device (CRᵢ) and a charging efficiency of the given electrical device (Efᵢ). At decision point 406, energy aggregator 102 may also determine whether third regulation value 406C is greater than or equal to zero, where third regulation value 406C is a ratio of the system-regulation value (RS) and a regulation-up capacity of the energy aggregator (R_{U}), multiplied by a ratio of minimum additional power draw of the given electrical device (MnAPi) and the charging efficiency of the given electrical device (Efᵢ), plus a ratio of the first power draw of the given electrical device (POPᵢ) and the charging efficiency of the given electrical device (Efᵢ), plus a state of charge of the given electrical device (SOCᵢ).

Decision point 406 may be represented by Equation 34.

$$\frac{RS}{{R}_{U}} {MnAP}_{i} + {POP}_{i} < \frac{{CR}_{i}}{{Ef}_{i}} \\ AND \\ \frac{RS}{{R}_{U}} \frac{{MnAP}_{i}}{{Ef}_{i}} + \frac{{POP}_{i}}{{Ef}_{i}} + {SOC}_{i} \geq 0 \qquad ( 34 )$$

If, at decision point 406, energy aggregator 102 determines that first regulation value 406A is less than second regulation value 406B and that third regulation value 406C is greater than or equal to 0, energy aggregator 102 may proceed to decision point 414 and determine that the second power draw is equal to first regulation value 406A (a ratio of the system-regulation value (RS) and a regulation-up capacity of the energy aggregator (R_{U}), multiplied by a minimum additional power draw of the given electrical device (MnAPi), plus the first power draw of the given electrical device (POPᵢ)).

If, at decision point 406, energy aggregator 102 determines either that first regulation value 406A is greater than second regulation value 406B or that third regulation value 406C is less than 0, energy aggregator 102 may proceed to decision point 412, where energy aggregator 102 may determine whether third regulation value 406C is greater than or equal to 0. Decision point 412 may be represented by Equation 35.

$$\frac{RS}{{R}_{U}} \frac{{MnAP}_{i}}{{Ef}_{i}} + \frac{{POP}_{i}}{{Ef}_{i}} + {SOC}_{I} \geq 0 \qquad ( 35 )$$

If, at decision point 412, energy aggregator 102 determines that third regulation value 412 is greater than or equal to 0, energy aggregator 102 may proceed to decision point 422 and determine that the second power draw is equal to second regulation value 406B (a ratio of a charge remaining to be supplied to the given electrical device (CRᵢ) and a charging efficiency of the given electrical device (Efᵢ)).

If, at decision point 412, energy aggregator 102 determines that third regulation value 412 is less than 0, energy aggregator 102 may proceed to decision point 420 and determine that the second power draw is equal to the inverse of the state of charge of the given electrical device (−SOCᵢ) multiplied by the charging efficiency of the given electrical device (Efᵢ).

If, at decision point 402, energy aggregator 102 determines that the electrical-system-regulation value (RS) does not exceed system-regulation-value threshold 402A, then energy aggregator 102 may proceed to decision point 404 where energy aggregator 102 may determine whether first regulation value 404A is less than second regulation value 404B, where first regulation value 404A is a ratio of the electrical-system-regulation value (RS) and a regulation-down capacity of the energy aggregator (R_{D}), multiplied by a maximum additional power draw of the given electrical device (MxAPᵢ), plus the first power draw of the given electrical device (POPᵢ), and where second regulation value 404B is a ratio of a charge remaining to be supplied to the given electrical device (CRᵢ) and a charging efficiency of the given electrical device (Efᵢ). At decision point 404, energy aggregator 102 may also determine whether third regulation value 404C is greater than or equal to 0, where third regulation value 404C is a ratio of the system-regulation value (RS) and a regulation-up capacity of the energy aggregator (R_{U}), multiplied by a ratio of maximum additional power draw of the given electrical device (MxAPi) and the charging efficiency of the given electrical device (Efᵢ), plus a ratio of the first power draw of the given electrical device (POPᵢ) and the charging efficiency of the given electrical device (Efᵢ), plus a state of charge of the given electrical device (SOCᵢ).

Decision point 404 may be represented by Equation 36.

$$\frac{RS}{{R}_{D}} {MxAP}_{i} + {POP}_{i} < \frac{{CR}_{i}}{{Ef}_{i}} \\ AND \\ \frac{RS}{{R}_{U}} \frac{{MxAP}_{i}}{{Ef}_{i}} + \frac{{POP}_{i}}{{Ef}_{i}} + {SOC}_{i} \geq 0 \qquad ( 36 )$$

If, at decision point 404, energy aggregator 102 determines that first regulation value 404A is less than second regulation value 404B and that third regulation value 406C is greater than or equal to 0, energy aggregator 102 may proceed to decision point 410 and determine that the second power draw is equal to first regulation value 404A (a ratio of the electrical-system-regulation value (RS) and a regulation-down capacity of the energy aggregator (R_{D}), multiplied by a maximum additional power draw of the given electrical device (MxAPᵢ), plus the first power draw of the given electrical device (POPᵢ)).

If, at decision point 404, energy aggregator 102 determines either that first regulation value 404A is greater than second regulation value 404B or that third regulation value 404C is less than 0, energy aggregator 102 may proceed to decision point 408, where energy aggregator 102 may determine whether fourth regulation value 408A is greater than or equal to 0, where the fourth regulation value 408A is a ratio of the system-regulation value (RS) and a regulation-down capacity of the energy aggregator (R_{D}), multiplied by a ratio of maximum additional power draw of the given electrical device (MxAPi) and the charging efficiency of the given electrical device (Efᵢ), plus a ratio of the first power draw of the given electrical device (POPᵢ) and the charging efficiency of the given electrical device (Efᵢ), plus a state of charge of the given electrical device (SOCᵢ). Decision point 408 may be represented by Equation 37.

$$\frac{RS}{{R}_{D}} \frac{{MnAP}_{i}}{{Ef}_{i}} + \frac{{POP}_{i}}{{Ef}_{i}} + {SOC}_{I} \geq 0 \qquad ( 37 )$$

If, at decision point 408, energy aggregator 102 determines that fourth regulation value 412 is greater than or equal to 0, energy aggregator 102 may proceed to decision point 418 and determine that the second power draw is equal to second regulation value 404B (a ratio of a charge remaining to be supplied to the given electrical device (CRᵢ) and a charging efficiency of the given electrical device (Efᵢ)).

If, at decision point 408, energy aggregator 102 determines that fourth regulation value 412 is less than 0, energy aggregator 102 may proceed to decision point 416 and determine that the second power draw is equal to the inverse of the state of charge of the given electrical device (−SOCᵢ) multiplied by the charging efficiency of the given electrical device (Efᵢ).

FIG. 5 depicts simplified regulation-algorithm flowchart 500 in accordance with some embodiments. Regulation-algorithm flowchart 500 represents an algorithm corresponding to when energy-aggregator 102 receives a regulation-variance value that is a responsive-reserve-regulation value (RRS). At decision point 502, energy aggregator 102 determines whether the responsive-reserve-regulation value (RRS) exceeds responsive-reserve-regulation-value threshold 502A. Note that, in the example shown in FIG. 5, responsive-reserve-regulation-value threshold 502A is shown as being equal to “0.” However, this is for purposes of example and explanation only, and should not be taken to be limiting.

If, at decision point 502, energy aggregator 102 determines that the responsive-reserve-regulation value (RRS) exceeds responsive-reserve-regulation-value threshold 502A, then energy aggregator 102 may proceed to decision point 504 where energy aggregator 102 may determine whether first regulation value 504A is less than second regulation value 504B, where first regulation value 504A is a ratio of responsive-reserve-regulation value (RRS) and a responsive-reserve capacity of the energy aggregator (R_{R}), multiplied by a reduction in power draw available for spinning reserves of the given electrical device (RsRPᵢ), plus the power draw of the current power draw of the given electrical device (PDᵢ), and where second regulation value 504B is a ratio of a charge remaining to be supplied to the given electrical device (CRᵢ) and a charging efficiency of the given electrical device (Efᵢ). At decision point 504, energy aggregator 102 may also determine whether third regulation value 504C is greater than or equal to zero, where third regulation value 504C is a ratio of responsive-reserve-regulation value (RRS) and a responsive-reserve capacity of the energy aggregator (R_{R}), multiplied by a reduction in power draw available for spinning reserves of the given electrical device (RsRPᵢ), plus a state of charge of the given electrical device (SOCᵢ), plus the first power draw of the given electrical device (POPᵢ).

Decision point 504 may be represented by Equation 38.

$$\frac{RSS}{{R}_{R}} {RsRP}_{i} + {PD}_{i} < \frac{{CR}_{i}}{{Ef}_{i}} \\ AND \\ \frac{RSS}{{R}_{R}} {RsRP}_{i} + {SOC}_{i} + {POP}_{i} \geq 0 \qquad ( 38 )$$

If, at decision point 504, energy aggregator 102 determines that first regulation value 504A is less than second regulation value 504B, energy aggregator 102 may proceed to decision point 508 and determine that the second power draw is equal to first regulation value 504A (a ratio of responsive-reserve-regulation value (RRS) and a responsive-reserve capacity of the energy aggregator (R_{R}), multiplied by a reduction in power draw available for spinning reserves of the given electrical device (RsRPᵢ), plus the power draw of the current power draw of the given electrical device (PDᵢ)).

If, at decision point 504, energy aggregator 102 determines either that first regulation value 504A is greater than second regulation value 504B or that third regulation value 504C is less than 0, energy aggregator 102 may proceed to decision point 506, where energy aggregator 102 may determine whether fourth regulation value 506A is greater than or equal to 0, where fourth regulation value 506A is (a ratio of responsive-reserve-regulation value (RRS) and a responsive-reserve capacity of the energy aggregator (R_{R}), multiplied by a ratio of a reduction in power draw available for spinning reserves of the given electrical device (RsRPᵢ) and a charging efficiency of the given electrical device (Efᵢ), plus a state of charge of the given electrical device (SOCᵢ), plus a ratio of the first power draw of the given electrical device (POPᵢ) and a charging efficiency of the given electrical device (Efᵢ)).

Decision point 506 may be represented by Equation 39.

$$\frac{RSS}{{R}_{R}} \frac{{RsRP}_{i}}{{Ef}_{i}} + {SOC}_{i} + \frac{{POP}_{i}}{{Ef}_{i}} \geq 0 \qquad ( 39 )$$

If, at decision point 506, energy aggregator 102 determines that fourth regulation value 506 is greater than or equal to 0, energy aggregator 102 may proceed to decision point 512 and determine that the second power draw is equal to second regulation value 504B (a ratio of a charge remaining to be supplied to the given electrical device (CRᵢ) and a charging efficiency of the given electrical device (Efᵢ)).

If, at decision point 506, energy aggregator 102 determines that fourth regulation value 506 is less than 0, energy aggregator 102 may proceed to decision point 510 and determine that the second power draw is equal to the inverse of the state of charge of the given electrical device (−SOCᵢ) multiplied by the charging efficiency of the given electrical device (Efᵢ).

iv. Transmit Power-Draw Message Indicating Second Power Draw

At block 308, energy aggregator 102 transmits to the given electrical device a power-draw message indicating the determined second power draw. For example, energy aggregator 102 may transmit the power-draw message to parking facility 112 via communication link 108B, which may be relayed directly or indirectly to one of electric vehicles 112A-112C via communication links 108C-108E, respectively. As another example, energy aggregator 102 may transmit the power-draw message to electric vehicle 116 via communication link 110A.

As noted above, the second power draw may be a dispatched power draw, and accordingly, a given electrical device that receives the power-draw message may respond by adjusting the power draw of its battery to correspond (or to equal) the second power draw indicated in the power-draw message. In this way, the power draw of the given electrical device may vary in time, according to the second power draw determined by energy aggregator 102 for the given electrical device.

For purposes of example and explanation, FIG. 6A depicts power-draw chart 610 in accordance with some embodiments. FIG. 6A represents an example power draw 614 (PDᵢ) of a given electrical device. Note that in FIG. 6A, the amount of power draw of the given electrical device is shown as the vertical axis 610A and time is shown as the horizontal axis 610B. Also note that power-draw chart 610 represents an example power draw 614 of a given electrical device in an embodiment where energy-aggregator 102 regulates power draw in response to a regulation-variance value that is an electrical-system regulation value (RS).

Additionally, the first power draw (scheduled power draw or preferred operating point) 612 of the given electrical device is shown as constant in time. Thus, power draw 614 varies with time around, generally, first power draw 612 according to the second power draw indicated in the power-draw message provided by energy aggregator 102.

Further, power-draw chart 610 shows the maximum possible power draw of the given electrical device 516 (MPᵢ). Further still, power-draw chart 610 shows the maximum additional power draw of the given electrical device 618 (MxAPi), as well as the minimum additional power-draw of the given electrical device 620 (MnAPᵢ).

For purposes of example and explanation, FIG. 6B depicts state-of-charge chart 630 in accordance with some embodiments. FIG. 6B represents an example state of charge 632 (SOCᵢ) of a given electrical device. Note that in FIG. 6B, the state of charge of the given electrical device is shown as the vertical axis 630A and time is shown as the horizontal axis 630B.

Additionally, state-of-charge chart 630 shows a maximum charge capacity of the given electrical device 634 (MCᵢ), and a charge remaining to be supplied to the given electrical device 636 (CRᵢ). The state of charge 632 is shown as generally increasing with time (although at varying rates, in accordance with the second power draw indicated by the received power-draw message). It should be understood, however, that this is not necessary. For example, in the event that the given electrical device discharges, the state of charge 632 may decrease.

As noted above, the power draw of the electrical device may additionally be varied for the purposes of providing responsive reserves to electrical system 100. For purposes of example and explanation, FIG. 7 depicts power-draw chart 710 in accordance with some embodiments. FIG. 7 represents an example power draw 714 (PDᵢ) of a given electrical device. Note that in FIG. 7, the amount of power draw of the given electrical device is shown as the vertical axis 710A and time is shown as the horizontal axis 710B. Also note that power-draw chart 710 represents an example power draw 714 of a given electrical device in an embodiment where energy-aggregator 102 regulates power draw in response to a regulation-variance value that is a responsive-reserve-regulation value (RRS).

Additionally, the first power draw (scheduled power draw or preferred operating point) 712 of the given electrical device is shown as constant in time. Thus, power draw 714 varies in time around, generally, first power draw 712 according to the second power draw indicated in the power-draw message provided by energy aggregator 102.

Further, power-draw chart 710 shows the maximum possible power draw of the given electrical device 716 (MPᵢ). Further still, power-draw chart 710 shows the maximum additional power draw of the given electrical device 718 (MxAPi), as well as the minimum additional power-draw of the given electrical device 726 (MnAPᵢ). And power-draw chart 710 shows the reduction in power draw available for spinning reserves of the given electrical device 728 (RsRPᵢ).

Further still, in accordance with the provisioning of responsive reserves, power-draw chart 710 also shows responsive-reserve amount 722 (which is generally equal to a ratio of responsive-reserve-regulation value (RRS) and a responsive-reserve capacity of the energy aggregator (R_{R}), multiplied by a reduction in power draw available for spinning reserves of the given electrical device (RsRPᵢ)). As shown by second power draw 724, power draw 714 (PDᵢ) may be modified according to the responsive-requirements of electrical system 100. That is, in the example shown by power chart 810 electrical system 100 may have experienced an unexpected spike in energy consumed by electrical system 100, and therefore energy aggregator 102 provided a regulation-up service to electrical-system operator 104A by directing the given electrical device to temporary reduce its dispatched power draw or directing the electrical device to discharge (as reflected by second power draw 724).

### III. EXAMPLE COMPUTER READABLE MEDIUM

In some embodiments, the disclosed methods may be implemented by computer program logic, or instructions, encoded on a non-transitory computer-readable storage media in a machine-readable format, or on other non-transitory media or articles of manufacture. FIG. 8 is a schematic illustrating a conceptual partial view of an example computer program product that includes a computer program for executing a computer process on a computing device, arranged according to at least some embodiments presented herein.

In one embodiment, the example computer program product 800 is provided using a signal bearing medium 802. The signal bearing medium 802 may include one or more programming instructions 804 that, when executed by one or more processors may provide functionality or portions of the functionality described herein. In some examples, the signal bearing medium 802 may encompass a computer-readable medium 806, such as, but not limited to, a hard disk drive, a Compact Disc (CD), a Digital Video Disk (DVD), a digital tape, memory, etc. In some implementations, the signal bearing medium 802 may encompass a computer recordable medium 808, such as, but not limited to, memory, read/write (R/W) CDs, R/W DVDs, etc. In some implementations, the signal bearing medium 802 may encompass a communications medium 810, such as, but not limited to, a digital and/or an analog communication medium (e.g., a fiber optic cable, a waveguide, a wired communications link, a wireless communication link, etc.). Thus, for example, the signal bearing medium 802 may be conveyed by a wireless form of the communications medium 810. It should be understood, however, that computer-readable medium 806, computer recordable medium 808, and communications medium 810 as contemplated herein are distinct mediums and that, in any event, computer-readable medium 808 is a physical, non-transitory, computer-readable medium.

The one or more programming instructions 804 may be, for example, computer executable and/or logic implemented instructions. In some examples, a computing device such as that shown in FIG. 2 may be configured to provide various operations, functions, or actions in response to the programming instructions 804 conveyed to the computing device by one or more of the computer readable medium 806, the computer recordable medium 808, and/or the communications medium 810.

The non-transitory computer readable medium could also be distributed among multiple data storage elements, which could be remotely located from each other. The computing device that executes some or all of the stored instructions could be a computing device, such as the computing device illustrated in FIG. 2. Alternatively, the computing device that executes some or all of the stored instructions could be another computing device.

### IV. CONCLUSION

It is intended that the foregoing detailed description be regarded as illustrative rather than limiting and that it is understood that the following claims including all equivalents are intended to define the scope of the invention. The claims should not be read as limited to the described order or elements unless stated to that effect. Therefore, all embodiments that come within the scope and spirit of the following claims and equivalents thereto are claimed as the invention.

We claim:

1. A method comprising:
determining, based on at least a respective amount of projected degradation in a given time period of each electrical device from a set of electrical devices, a respective first power draw of each electrical device for the given time period, wherein each electrical device is coupled to an electrical system;
receiving, from an electrical system operator, a regulation-variance value that indicates a variation from a scheduled power consumption of the electrical system;
determining a second power draw for a given electrical device from the set of electrical devices based on at least the determined respective first power draw for each electrical device and the received regulation-variance value; and
transmitting to the given electrical device a power-draw message indicating the determined second power draw.

2. The method of claim 1, wherein the respective first power draw is a respective scheduled power draw of each electrical device.

3. The method of claim 1, wherein the second power draw is a dispatched power draw of the given electrical device.

4. The method of claim 1, wherein determining, based on at least the respective amount of projected degradation in the given time period of each electrical device from the set of electrical devices, the respective first power draw of each electrical device for the given time period, comprises:
maximizing an energy-aggregator profit based on at least the respective first power draw for each electrical device and the amount of projected degradation in the given time period of each electrical device.

5. The method of claim 4, wherein maximizing the energy-aggregator profit based on at least the respective first power draw for each electrical device and the amount of projected degradation in the given time period of each electrical device, comprises:
maximizing the energy-aggregator profit based on (i) the respective first power draw for each electrical device, (ii) the respective amount of projected degradation in the given time period of each electrical device, (iii) a respective maximum additional power draw for each electrical device, (iv) a respective minimum additional power draw for each electrical device, and (v) a respective reduction in power draw available for spinning reserves for each electrical device.

6. The method of claim 4, wherein the energy-aggregator profit is defined by at least one of an income of the energy aggregator and a cost to the energy aggregator, and wherein maximizing the energy-aggregator profit based on at least the respective first power draw for each electrical device and the amount of projected degradation in the given time period of each electrical device, comprises:
maximizing the energy-aggregator profit subject to a set of conditions, the set of conditions defined by at least (a) the respective first power draw of each electrical device, (b) the amount of projected degradation in the given time period of each electrical device, and (c) a respective efficiency of each electrical device.

7. The method of claim 5, wherein the energy-aggregator profit is defined by at least the income of the energy aggregator, and wherein the income of the energy aggregator is determined based on at least a regulation-service income and an energy-supply-service income.

8. The method of claim 5, wherein the energy-aggregator profit is defined by at least the cost to the energy aggregator, and the cost to the energy aggregator is determined based on at least (a) a respective expected value of the final power draw of each electrical device, (b) a cost of energy, (c) a respective projected degradation cost of each electrical device, and (d) a respective efficiency of each electrical device.

9. The method of claim 1, wherein the set of conditions is further defined by at least (a) a respective expected value of the final power draw of each electrical device, (b) a respective projected degradation cost of each electrical device, (c) a respective initial state of charge of each electrical device, (d) a reduction in a state of charge associated with a trip, (e) a respective maximum additional power draw for each electrical device, (f) a respective minimum additional power draw for each electrical device, (g) a respective reduction in power draw available for spinning reserves for each electrical device, (h) a respective maximum charge capacity of each electrical device, (i) a respective maximum possible power draw of each electrical device, (j) a maximum day-ahead forecasted net load of the electrical system, (k) a minimum day-ahead forecasted net load of the electrical system, and (l) an actual net load of the electrical system.

10. The method of claim 1, wherein the regulation-variance value is at least one of (i) an electrical-system-regulation value and (ii) a responsive-reserve-regulation value.

11. The method of claim 10, wherein determining the second power draw comprises an energy aggregator determining the second power draw based on at least the respective first power draw for each electrical device and at least the electrical-system-regulation value, and wherein the energy aggregator determining the second power draw comprises:
determining that the electrical-system-regulation value does not exceed a system-regulation-value threshold;
determining that (a) a first regulation value is less than a second regulation value and (b) that a third regulation value is greater than or equal to zero, wherein the first regulation value is a ratio of (a) the system-regulation value and (b) a regulation-down capacity of the energy aggregator, multiplied by a maximum additional power draw of the given electrical device, plus the first power draw of the given electrical device, wherein the second regulation value is a ratio of (a) a charge remaining to be supplied to the given electrical device and (b) a charging efficiency of the given electrical device, and wherein the third regulation value is a ratio of (a) the system-regulation value and (b) a regulation-up capacity of the energy aggregator, multiplied by a ratio of (a) maximum additional power draw of the given electrical device and (b) the charging efficiency of the given electrical device, plus a ratio of (a) the first power draw of the given electrical device and (b) the charging efficiency of the given electrical device, plus a state of charge of the given electrical device; and
determining that the second power draw is equal to the first regulation value.

12. The method of claim 10, wherein determining the second power draw comprises an energy aggregator determining the second power draw based on at least the respective first power draw for each electrical device and at least the electrical-system-regulation value, and wherein the energy aggregator determining the second power draw comprises:
determining that the electrical-system-regulation value does not exceed a system-regulation-value threshold;
determining either that (a) a first regulation value is not less than a second regulation value or (b) that a third regulation value is not greater than or equal to zero, wherein the first regulation value is a ratio of (a) the system-regulation value and (b) a regulation-down capacity of the energy aggregator, multiplied by a maximum additional power draw of the given electrical device, plus the first power draw of the given electrical device, wherein the second regulation value is a ratio of (a) a charge remaining to be supplied to the given electrical device and (b) a charging efficiency of the given electrical device, and wherein the third regulation value is a ratio of (a) the system-regulation value and (b) a regulation-up capacity of the energy aggregator, multiplied by a ratio of (a) the maximum additional power draw of the given electrical device and (b) the charging efficiency of the given electrical device, plus a ratio of (a) the first power draw of the given electrical device and (b) the charging efficiency of the given electrical device, plus a state of charge of the given electrical device;
determining that a fourth regulation value is greater than or equal to zero, wherein the fourth regulation value is a ratio of (a) the system-regulation value and (b) the regulation-down capacity of the energy aggregator, multiplied by a ratio of (a) the maximum additional power draw of the given electrical device and (b) the charging efficiency of the given electrical device, plus a ratio of (a) the first power draw of the given electrical device and (b) the charging efficiency of the given electrical device, plus the state of charge of the given electrical device; and
determining that the second power draw is equal to the second regulation value.

13. The method of claim 10, wherein determining the second power draw comprises an energy aggregator determining the second power draw based on at least the respective first power draw for each electrical device and at least the electrical-system-regulation value, and wherein the energy aggregator determining the second power draw comprises:
determining that the electrical-system-regulation value does not exceed a system-regulation-value threshold;
determining either that (a) a first regulation value is not less than a second regulation value or (b) that a third regulation value is not greater than or equal to zero, wherein the first regulation value is a ratio of (a) the system-regulation value and (b) a regulation-down capacity of the energy aggregator, multiplied by a maximum additional power draw of the given electrical device, plus the first power draw of the given electrical device, wherein the second regulation value is a ratio of (a) a charge remaining to be supplied to the given electrical device and (b) a charging efficiency of the given electrical device, and wherein the third regulation value is a ratio of (a) the system-regulation value and (b) a regulation-up capacity of the energy aggregator, multiplied by a ratio of (a) the maximum additional power draw of the given electrical device and (b) the charging efficiency of the given electrical device, plus a ratio of (a) the first power draw of the given electrical device and (b) the charging efficiency of the given electrical device, plus a state of charge of the given electrical device;
determining that a fourth regulation value is not greater than or equal to zero, wherein the fourth regulation value is a ratio of (a) the system-regulation value and (b) the regulation-down capacity of the energy aggregator, multiplied by a ratio of (a) the maximum additional power draw of the given electrical device and (b) the charging efficiency of the given electrical device, plus a ratio of (a) the first power draw of the given electrical device and (b) the charging efficiency of the given electrical device, plus the state of charge of the given electrical device; and
determining that the second power draw is equal to the inverse of the state of charge of the given electrical device multiplied by the charging efficiency of the given electrical device.

14. The method of claim 10, wherein determining the second power draw comprises an energy aggregator determining the second power draw based on at least the respective first power draw for each electrical device and at least the electrical-system-regulation value, and wherein the energy aggregator determining the second power draw comprises:
determining that the electrical-system-regulation value exceeds a system-regulation-value threshold;
determining that (a) a first regulation value is less than a second regulation value and (b) that a third regulation value is greater than or equal to zero, wherein the first regulation value is a ratio of (a) the system-regulation value and (b) a regulation-up capacity of the energy aggregator, multiplied by a minimum additional power draw of the given electrical device, plus the first power draw of the given electrical device, wherein the second regulation value is a ratio of (a) a charge remaining to be supplied to the given electrical device and (b) a charging efficiency of the given electrical device, and wherein the third regulation value is a ratio of (a) the system-regulation value and (b) a regulation-up capacity of the energy aggregator, multiplied by a ratio of (a) minimum additional power draw of the given electrical device and (b) the charging efficiency of the given electrical device, plus a ratio of (a) the first power draw of the given electrical device and (b) the charging efficiency of the given electrical device, plus a state of charge of the given electrical device; and
determining that the second power draw is equal to the first regulation value.

15. The method of claim 10, wherein determining the second power draw comprises an energy aggregator determining the second power draw based on at least the respective first power draw for each electrical device and at least the electrical-system-regulation value, and wherein the energy aggregator determining the second power draw comprises:
determining that the electrical-system-regulation value exceeds a system-regulation-value threshold;
determining either that (a) a first regulation value is not less than a second regulation value or (b) that a third regulation value is not greater than or equal to zero, wherein the first regulation value is a ratio of (a) the system-regulation value and (b) a regulation-up capacity of the energy aggregator, multiplied by a minimum additional power draw of the given electrical device, plus the first power draw of the given electrical device, wherein the second regulation value is a ratio of (a) a charge remaining to be supplied to the given electrical device and (b) a charging efficiency of the given electrical device, and wherein the third regulation value is a ratio of (a) the system-regulation value and (b) a regulation-up capacity of the energy aggregator, multiplied by a ratio of (a) minimum additional power draw of the given electrical device and (b) the charging efficiency of the given electrical device, plus a ratio of (a) the first power draw of the given electrical device and (b) the charging efficiency of the given electrical device, plus a state of charge of the given electrical device; and
determining that the third regulation value is greater than or equal to zero; and
determining that the second power draw is equal to the second regulation value.

16. The method of claim 10, wherein determining the second power draw comprises an energy aggregator determining the second power draw based on at least the respective first power draw for each electrical device and at least the electrical-system-regulation value, and wherein the energy aggregator determining the second power draw comprises:
determining that the electrical-system-regulation value exceeds a system-regulation-value threshold;
determining either that (a) a first regulation value is not less than a second regulation value or (b) that a third regulation value is not greater than or equal to zero, wherein the first regulation value is a ratio of (a) the system-regulation value and (b) a regulation-down capacity of the energy aggregator, multiplied by a maximum additional power draw of the given electrical device, plus the first power draw of the given electrical device, wherein the second regulation value is a ratio of (a) a charge remaining to be supplied to the given electrical device and (b) a charging efficiency of the given electrical device, and wherein the third regulation value is a ratio of (a) the system-regulation value and (b) a regulation-up capacity of the energy aggregator, multiplied by a ratio of (a) the maximum additional power draw of the given electrical device and (b) the charging efficiency of the given electrical device, plus a ratio of (a) the first power draw of the given electrical device and (b) the charging efficiency of the given electrical device, plus a state of charge of the given electrical device;
determining that the third regulation value is less than zero; and
determining that the second power draw is equal to the inverse of the state of charge of the given electrical device multiplied by the charging efficiency of the given electrical device.

17. The method of claim 10, wherein determining the second power draw comprises an energy aggregator determining the second power draw based on at least the respective first power draw for each electrical device and at least the responsive-reserve-regulation value, and wherein the energy aggregator determining the second power draw comprises:
determining that the responsive-reserve-regulation value exceeds a responsive-reserve-regulation-value threshold;
determining (a) that a first regulation value is less than a second regulation value and (b) that a third regulation value is greater than or equal to zero, wherein the first regulation value is a ratio of (a) the responsive-reserve-regulation value and (b) a responsive-reserve capacity of the energy aggregator, multiplied by a reduction in power draw available for spinning reserves for the given electrical device, plus the current power draw of the given electrical device, wherein the second regulation value is a ratio of (a) a charge remaining to be supplied to the given electrical device and (b) a charging efficiency of the given electrical device, and wherein the third regulation value is a ratio of (a) the responsive-reserve-regulation value and (b) a responsive-reserve capacity of the energy aggregator, multiplied by a reduction in power draw available for spinning reserves for the given electrical device, plus a state of charge of the given electrical device, plus the first power draw of the given electrical device; and
determining that the second power draw is equal to the first regulation value.

18. The method of claim 10, wherein determining the second power draw comprises an energy aggregator determining the second power draw based on at least the respective first power draw for each electrical device and at least the responsive-reserve-regulation value, and wherein the energy aggregator determining the second power draw comprises:
determining that the responsive-reserve-regulation value exceeds a responsive-reserve-regulation-value threshold;
determining either (a) that a first regulation value is not less than a second regulation value or (b) that a third regulation value is not greater than or equal to zero, wherein the first regulation value is a ratio of (a) the responsive-reserve-regulation value and (b) a responsive-reserve capacity of the energy aggregator, multiplied by a reduction in power draw available for spinning reserves for the given electrical device, plus the current power draw of the given electrical device, wherein the second regulation value is a ratio of (a) a charge remaining to be supplied to the given electrical device and (b) a charging efficiency of the given electrical device, and wherein the third regulation value is a ratio of (a) the responsive-reserve-regulation value and (b) a responsive-reserve capacity of the energy aggregator, multiplied by a reduction in power draw available for spinning reserves for the given electrical device, plus a state of charge of the given electrical device, plus the first power draw of the given electrical device;
determining that a fourth regulation value is greater than or equal to zero, wherein the fourth regulation value is a ratio of (a) the responsive-reserve-regulation value and (b) the responsive-reserve capacity of the energy aggregator, multiplied by a ratio of (a) the reduction in power draw available for spinning reserves for the given electrical device and (b) the charging efficiency of the given electrical device, plus the state of charge of the given electrical device, plus a ratio of (a) the first power draw of the given electrical device and (b) the charging efficiency of the given electrical device; and
determining that the second power draw is equal to the second regulation value.

19. The method of claim 10, wherein determining the second power draw comprises an energy aggregator determining the second power draw based on at least the respective first power draw for each electrical device and at least the responsive-reserve-regulation value, and wherein the energy aggregator determining the second power draw comprises:
determining that the responsive-reserve-regulation value exceeds a responsive-reserve-regulation-value threshold;
determining either (a) that a first regulation value is not less than a second regulation value or (b) that a third regulation value is not greater than or equal to zero, wherein the first regulation value is a ratio of (a) the responsive-reserve-regulation value and (b) a responsive-reserve capacity of the energy aggregator, multiplied by a reduction in power draw available for spinning reserves for the given electrical device, plus the current power draw of the given electrical device, wherein the second regulation value is a ratio of (a) a charge remaining to be supplied to the given electrical device and (b) a charging efficiency of the given electrical device, and wherein the third regulation value is a ratio of (a) the responsive-reserve-regulation value and (b) a responsive-reserve capacity of the energy aggregator, multiplied by a reduction in power draw available for spinning reserves for the given electrical device, plus a state of charge of the given electrical device, plus the first power draw of the given electrical device;
determining that a fourth regulation value is not greater than or equal to zero, wherein the fourth regulation value is a ratio of (a) the responsive-reserve-regulation value and (b) the responsive-reserve capacity of the energy aggregator, multiplied by a ratio of (a) the reduction in power draw available for spinning reserves for the given electrical device and (b) the charging efficiency of the given electrical device, plus the state of charge of the given electrical device, plus a ratio of (a) the first power draw of the given electrical device and (b) the charging efficiency of the given electrical device; and
determining that the second power draw is equal to the inverse of the state of charge of the given electrical device multiplied by the charging efficiency of the given electrical device.

20. A computing device comprising:
a non-transitory computer readable medium; and
program instructions stored on the non-transitory computer readable medium and executable by at least one processor to cause the computing device to:
determine, based on at least a respective amount of projected degradation in a given time period of each electrical device from a set of electrical devices, a respective first power draw of each electrical device for the given time period, wherein each electrical device is coupled to an electrical system;
receive, from an electrical system operator, a regulation-variance value that indicates a variation from a scheduled power consumption of the electrical system;
determine a second power draw for a given electrical device from the set of electrical devices based on at least the determined respective first power draw for each electrical device and the received regulation-variance value; and
transmit to the given electrical device a power-draw message indicating the determined second power draw.

21. The computing device of claim 20, wherein determining, based on at least the respective amount of projected degradation in the given time period of each electrical device from the set of electrical devices, the respective first power draw of each electrical device for the given time period, comprises:
maximizing an energy-aggregator profit based on at least the respective first power draw for each electrical device and the amount of projected degradation in the given time period of each electrical device.

22. The computing device of claim 21, wherein maximizing the energy-aggregator profit based on at least the respective first power draw for each electrical device and the amount of projected degradation in the given time period of each electrical device, comprises:
maximizing the energy-aggregator profit subject to a set of conditions, the set of conditions defined by at least (a) the respective first power draw of each electrical device, (b) the amount of projected degradation in the given time period of each electrical device, and (c) a respective efficiency of each electrical device.

23. The computing device of claim 22, wherein the set of conditions is further defined by at least (a) a respective expected final power draw of each electrical device, (b) a respective projected degradation cost of each electrical device, (c) a respective initial state of charge of each electrical device, (d) a reduction in a state of charge associated with a trip, (e) a respective maximum additional power draw for each electrical device, (f) a respective minimum additional power draw for each electrical device, (g) a respective reduction in power draw available for spinning reserves for each electrical device, (h) a respective maximum charge capacity of each electrical device, (i) a respective maximum possible power draw of each electrical device, (j) a maximum day-ahead forecasted net load of the electrical system, (k) a minimum day-ahead forecasted net load of the electrical system, and (l) an actual net load of the electrical system.

24. The computing device of claim 20, wherein the regulation-variance value is at least one of (i) an electrical-system-regulation value and (ii) a responsive-reserve-regulation value.

25. The computing device of claim 24, wherein determining the second power draw comprises an energy aggregator determining the second power draw based on at least the respective first power draw for each electrical device and at least the electrical-system-regulation value, and wherein the energy aggregator determining the second power draw comprises:
determining that the electrical-system-regulation value does not exceed a system-regulation-value threshold;
determining that (a) a first regulation value is less than a second regulation value and (b) that a third regulation value is greater than or equal to zero, wherein the first regulation value is a ratio of (a) the system-regulation value and (b) a regulation-down capacity of the energy aggregator, multiplied by a maximum additional power draw of the given electrical device, plus the first power draw of the given electrical device, wherein the second regulation value is a ratio of (a) a charge remaining to be supplied to the given electrical device and (b) a charging efficiency of the given electrical device, and wherein the third regulation value is a ratio of (a) the system-regulation value and (b) a regulation-up capacity of the energy aggregator, multiplied by a ratio of (a) maximum additional power draw of the given electrical device and (b) the charging efficiency of the given electrical device, plus a ratio of (a) the first power draw of the given electrical device and (b) the charging efficiency of the given electrical device, plus a state of charge of the given electrical device; and
determining that the second power draw is equal to the first regulation value.

26. The computing device of claim 24, wherein determining the second power draw comprises an energy aggregator determining the second power draw based on at least the respective first power draw for each electrical device and at least the electrical-system-regulation value, and wherein the energy aggregator determining the second power draw comprises:
determining that the electrical-system-regulation value does not exceed a system-regulation-value threshold;
determining either that (a) a first regulation value is not less than a second regulation value or (b) that a third regulation value is not greater than or equal to zero, wherein the first regulation value is a ratio of (a) the system-regulation value and (b) a regulation-down capacity of the energy aggregator, multiplied by a maximum additional power draw of the given electrical device, plus the first power draw of the given electrical device, wherein the second regulation value is a ratio of (a) a charge remaining to be supplied to the given electrical device and (b) a charging efficiency of the given electrical device, and wherein the third regulation value is a ratio of (a) the system-regulation value and (b) a regulation-up capacity of the energy aggregator, multiplied by a ratio of (a) the maximum additional power draw of the given electrical device and (b) the charging efficiency of the given electrical device, plus a ratio of (a) the first power draw of the given electrical device and (b) the charging efficiency of the given electrical device, plus a state of charge of the given electrical device;
determining that a fourth regulation value is greater than or equal to zero, wherein the fourth regulation value is a ratio of (a) the system-regulation value and (b) the regulation-down capacity of the energy aggregator, multiplied by a ratio of (a) the maximum additional power draw of the given electrical device and (b) the charging efficiency of the given electrical device, plus a ratio of (a) the first power draw of the given electrical device and (b) the charging efficiency of the given electrical device, plus the state of charge of the given electrical device; and
determining that the second power draw is equal to the second regulation value.

27. The computing device of claim 24, wherein determining the second power draw comprises an energy aggregator determining the second power draw based on at least the respective first power draw for each electrical device and at least the electrical-system-regulation value, and wherein the energy aggregator determining the second power draw comprises:
determining that the electrical-system-regulation value does not exceed a system-regulation-value threshold;
determining either that (a) a first regulation value is not less than a second regulation value or (b) that a third regulation value is not greater than or equal to zero, wherein the first regulation value is a ratio of (a) the system-regulation value and (b) a regulation-down capacity of the energy aggregator, multiplied by a maximum additional power draw of the given electrical device, plus the first power draw of the given electrical device, wherein the second regulation value is a ratio of (a) a charge remaining to be supplied to the given electrical device and (b) a charging efficiency of the given electrical device, and wherein the third regulation value is a ratio of (a) the system-regulation value and (b) a regulation-up capacity of the energy aggregator, multiplied by a ratio of (a) the maximum additional power draw of the given electrical device and (b) the charging efficiency of the given electrical device, plus a ratio of (a) the first power draw of the given electrical device and (b) the charging efficiency of the given electrical device, plus a state of charge of the given electrical device;
determining that a fourth regulation value is not greater than or equal to zero, wherein the fourth regulation value is a ratio of (a) the system-regulation value and (b) the regulation-down capacity of the energy aggregator, multiplied by a ratio of (a) the maximum additional power draw of the given electrical device and (b) the charging efficiency of the given electrical device, plus a ratio of (a) the first power draw of the given electrical device and (b) the charging efficiency of the given electrical device, plus the state of charge of the given electrical device; and
determining that the second power draw is equal to the inverse of the state of charge of the given electrical device multiplied by the charging efficiency of the given electrical device.

28. The computing device of claim 24, wherein determining the second power draw comprises an energy aggregator determining the second power draw based on at least the respective first power draw for each electrical device and at least the electrical-system-regulation value, and wherein the energy aggregator determining the second power draw comprises:
determining that the electrical-system-regulation value exceeds a system-regulation-value threshold;
determining that (a) a first regulation value is less than a second regulation value and (b) that a third regulation value is greater than or equal to zero, wherein the first regulation value is a ratio of (a) the system-regulation value and (b) a regulation-up capacity of the energy aggregator, multiplied by a minimum additional power draw of the given electrical device, plus the first power draw of the given electrical device, wherein the second regulation value is a ratio of (a) a charge remaining to be supplied to the given electrical device and (b) a charging efficiency of the given electrical device, and wherein the third regulation value is a ratio of (a) the system-regulation value and (b) a regulation-up capacity of the energy aggregator, multiplied by a ratio of (a) minimum additional power draw of the given electrical device and (b) the charging efficiency of the given electrical device, plus a ratio of (a) the first power draw of the given electrical device and (b) the charging efficiency of the given electrical device, plus a state of charge of the given electrical device; and
determining that the second power draw is equal to the first regulation value.

29. The computing device of claim 24, wherein determining the second power draw comprises an energy aggregator determining the second power draw based on at least the respective first power draw for each electrical device and at least the electrical-system-regulation value, and wherein the energy aggregator determining the second power draw comprises:
determining that the electrical-system-regulation value exceeds a system-regulation-value threshold;
determining either that (a) a first regulation value is not less than a second regulation value or (b) that a third regulation value is not greater than or equal to zero, wherein the first regulation value is a ratio of (a) the system-regulation value and (b) a regulation-up capacity of the energy aggregator, multiplied by a minimum additional power draw of the given electrical device, plus the first power draw of the given electrical device, wherein the second regulation value is a ratio of (a) a charge remaining to be supplied to the given electrical device and (b) a charging efficiency of the given electrical device, and wherein the third regulation value is a ratio of (a) the system-regulation value and (b) a regulation-up capacity of the energy aggregator, multiplied by a ratio of (a) minimum additional power draw of the given electrical device and (b) the charging efficiency of the given electrical device, plus a ratio of (a) the first power draw of the given electrical device and (b) the charging efficiency of the given electrical device, plus a state of charge of the given electrical device; and
determining that the third regulation value is greater than or equal to zero; and
determining that the second power draw is equal to the second regulation value.

30. The computing device of claim 24, wherein determining the second power draw comprises an energy aggregator determining the second power draw based on at least the respective first power draw for each electrical device and at least the electrical-system-regulation value, and wherein the energy aggregator determining the second power draw comprises:
determining that the electrical-system-regulation value exceeds a system-regulation-value threshold;
determining either that (a) a first regulation value is not less than a second regulation value or (b) that a third regulation value is not greater than or equal to zero, wherein the first regulation value is a ratio of (a) the system-regulation value and (b) a regulation-down capacity of the energy aggregator, multiplied by a maximum additional power draw of the given electrical device, plus the first power draw of the given electrical device, wherein the second regulation value is a ratio of (a) a charge remaining to be supplied to the given electrical device and (b) a charging efficiency of the given electrical device, and wherein the third regulation value is a ratio of (a) the system-regulation value and (b) a regulation-up capacity of the energy aggregator, multiplied by a ratio of (a) the maximum additional power draw of the given electrical device and (b) the charging efficiency of the given electrical device, plus a ratio of (a) the first power draw of the given electrical device and (b) the charging efficiency of the given electrical device, plus a state of charge of the given electrical device;
determining that the third regulation value is less than zero; and
determining that the second power draw is equal to the inverse of the state of charge of the given electrical device multiplied by the charging efficiency of the given electrical device.

31. The computing device of claim 24, wherein determining the second power draw comprises an energy aggregator determining the second power draw based on at least the respective first power draw for each electrical device and at least the responsive-reserve-regulation value, and wherein the energy aggregator determining the second power draw comprises:
determining that the responsive-reserve-regulation value exceeds a responsive-reserve-regulation-value threshold;
determining (a) that a first regulation value is less than a second regulation value and (b) that a third regulation value is greater than or equal to zero, wherein the first regulation value is a ratio of (a) the responsive-reserve-regulation value and (b) a responsive-reserve capacity of the energy aggregator, multiplied by a reduction in power draw available for spinning reserves for the given electrical device, plus the current power draw of the given electrical device, wherein the second regulation value is a ratio of (a) a charge remaining to be supplied to the given electrical device and (b) a charging efficiency of the given electrical device, and wherein the third regulation value is a ratio of (a) the responsive-reserve-regulation value and (b) a responsive-reserve capacity of the energy aggregator, multiplied by a reduction in power draw available for spinning reserves for the given electrical device, plus a state of charge of the given electrical device, plus the first power draw of the given electrical device; and
determining that the second power draw is equal to the first regulation value.

32. The computing device of claim 24, wherein determining the second power draw comprises an energy aggregator determining the second power draw based on at least the respective first power draw for each electrical device and at least the responsive-reserve-regulation value, and wherein the energy aggregator determining the second power draw comprises:
determining that the responsive-reserve-regulation value exceeds a responsive-reserve-regulation-value threshold;
determining either (a) that a first regulation value is not less than a second regulation value or (b) that a third regulation value is not greater than or equal to zero, wherein the first regulation value is a ratio of (a) the responsive-reserve-regulation value and (b) a responsive-reserve capacity of the energy aggregator, multiplied by a reduction in power draw available for spinning reserves for the given electrical device, plus the current power draw of the given electrical device, wherein the second regulation value is a ratio of (a) a charge remaining to be supplied to the given electrical device and (b) a charging efficiency of the given electrical device, and wherein the third regulation value is a ratio of (a) the responsive-reserve-regulation value and (b) a responsive-reserve capacity of the energy aggregator, multiplied by a reduction in power draw available for spinning reserves for the given electrical device, plus a state of charge of the given electrical device, plus the first power draw of the given electrical device;
determining that a fourth regulation value is greater than or equal to zero, wherein the fourth regulation value is a ratio of (a) the responsive-reserve-regulation value and (b) the responsive-reserve capacity of the energy aggregator, multiplied by a ratio of (a) the reduction in power draw available for spinning reserves for the given electrical device and (b) the charging efficiency of the given electrical device, plus the state of charge of the given electrical device, plus a ratio of (a) the first power draw of the given electrical device and (b) the charging efficiency of the given electrical device; and
determining that the second power draw is equal to the second regulation value.

33. The computing device of claim 24, wherein determining the second power draw comprises an energy aggregator determining the second power draw based on at least the respective first power draw for each electrical device and at least the responsive-reserve-regulation value, and wherein the energy aggregator determining the second power draw comprises:
determining that the responsive-reserve-regulation value exceeds a responsive-reserve-regulation-value threshold;
determining either (a) that a first regulation value is not less than a second regulation value or (b) that a third regulation value is not greater than or equal to zero, wherein the first regulation value is a ratio of (a) the responsive-reserve-regulation value and (b) a responsive-reserve capacity of the energy aggregator, multiplied by a reduction in power draw available for spinning reserves for the given electrical device, plus the current power draw of the given electrical device, wherein the second regulation value is a ratio of (a) a charge remaining to be supplied to the given electrical device and (b) a charging efficiency of the given electrical device, and wherein the third regulation value is a ratio of (a) the responsive-reserve-regulation value and (b) a responsive-reserve capacity of the energy aggregator, multiplied by a reduction in power draw available for spinning reserves for the given electrical device, plus a state of charge of the given electrical device, plus the first power draw of the given electrical device;
determining that a fourth regulation value is not greater than or equal to zero, wherein the fourth regulation value is a ratio of (a) the responsive-reserve-regulation value and (b) the responsive-reserve capacity of the energy aggregator, multiplied by a ratio of (a) the reduction in power draw available for spinning reserves for the given electrical device and (b) the charging efficiency of the given electrical device, plus the state of charge of the given electrical device, plus a ratio of (a) the first power draw of the given electrical device and (b) the charging efficiency of the given electrical device; and
determining that the second power draw is equal to the inverse of the state of charge of the given electrical device multiplied by the charging efficiency of the given electrical device.

34. A physical computer-readable medium having computer executable instructions stored thereon, the instructions comprising:
instructions for determining, based on at least a respective amount of projected degradation in a given time period of each electrical device from a set of electrical devices, a respective first power draw of each electrical device for the given time period, wherein each electrical device is coupled to an electrical system;
instructions for receiving, from an electrical system operator, a regulation-variance value that indicates a variation from a scheduled power consumption of the electrical system;
instructions for determining a second power draw for a given electrical device from the set of electrical devices based on at least the determined respective first power draw for each electrical device and the received regulation-variance value; and
instructions for transmitting to the given electrical device a power-draw message indicating the determined second power draw.
